(19) United States
(12) Patent Application Publication
(10) Pub. No.: US 2019/0300811 A1
(43) Pub. Date: Oct. 3, 2019

(54) Block Copolymer Comprising a Polyalpha-Olefin Block and a Poly(Alkyl Methacrylate) Block

(71) Applicant: ExxonMobil Chemical Patents Inc., Baytown, TX (US)

(72) Inventors: Andy H. Tsou, Houston, TX (US); Hillary L. Passino, Houston, TX (US); Yong Yang, Kingwood, TX (US); Patrick C. Chen, Houston, TX (US); Alistair D. Westwood, Kingwood, TX (US)

(21) Appl. No.: 16/365,196

(22) Filed: Mar. 26, 2019

Related U.S. Application Data
(60) Provisional application No. 62/648,446, filed on Mar. 27, 2018.

(51) Int. Cl. C10M 145/14; C08F 293/00; C10M 107/02; C10M 169/04

(52) U.S. Cl. CPC C10M 145/14; C08F 293/005; C10M 107/02; C10M 169/041; C10N 2230/68; C08F 2420/01; C10M 2209/084; C10M 2205/0206; C10N 2220/022; C08F 2438/01

(57) ABSTRACT

A block copolymer comprising a PAO block derived from alpha-olefin monomer(s) having a carbon backbone comprising more than six (6) carbon atoms per molecule and a poly(alkyl methacrylate) block derived from alkyl methacrylate monomer(s) having an alkyl group comprising at least six (6) carbon atoms forms micelles in hydrocarbon solvents and lubricant oil base stocks with large space volume even at low overall molecular weight. The block copolymer of this disclosure is particularly advantageous as viscosity modifier for lubricant oil compositions.

### PRIORITY CLAIM

This application claims priority to and the benefit of U.S. Ser. No. 62/648,446, filed Mar. 27, 2018 and is incorporated herein by reference in its entirety.

### FIELD

This disclosure relates to polyalpha-olefin and poly(alkyl methacrylate) block copolymers, viscosity improvers and lubricant oil compositions. In particular, this disclosure relates to a block copolymer comprising a polyalphaolefin block having bottle-brush component(s) and a poly(alkyl methacrylate) block, and viscosity improvers and lubricant oil compositions comprising the aforementioned block copolymer.

### BACKGROUND

Viscosity modifiers (VM) are employed in combination with base stocks in the lubricant oil compositions to improve the viscosity index (VI) of the composition. A higher VI value indicates that the viscosity of the composition changes less as the temperature lowers from 100° C. to 40° C. A high VI is desirable for many lubricant oil compositions, including but not limited to automobile engine oils, driveline oils, industrial lubricant oils, and the like.

A VM desirably exhibits a high degree of thickening capability, i.e., relatively large increase in viscosity in the base stocks for the amount of VM used. A VM that exhibits a high degree of thickening capability typically exhibits large VM dimension in a base stock. Other desirable properties for a VM include shear stability, thermo-oxidative stability, a favorable low temperature viscometric, early onset of shear thinning, and a positive temperature coefficient. When a VM has a positive temperature coefficient in a lubricant base stock, viscosity of the VM containing base stock solution is less sensitive to temperature.

Five different classes of VM are currently employed by the industry in lubricant base stocks. The classes include OCPs (olefin copolymers), SIPs (hydrogenated styrene-isoprene copolymers), PMAs (polymethacrylates), SPE (esterified poly(styrene-co-maleic anhydride), and PMA/OCP compatibilized blends. The most commonly used VMs are OCPs, SIPs, and PMAs. The various classes of VM are described in Chemistry and Technology of Lubricants (P. M. Mortier and S. T. Orszulik, 3^{rd} Ed., Blackie Academic, New York, Chapter 5).

No single class of VM provides all the desired performance characteristics. OCPs exhibit the highest thickening capability but exhibit a negative temperature coefficient, a poor low temperature viscometric, and are prone to shear degradation. SIPs exhibit moderate thickening capability, but also have a negative temperature coefficient and are prone to thermo-oxidative degradation because of the polystyrene component. PMAs exhibit poor thickening capability but are the only VM class that exhibits a positive temperature coefficient and excellent low temperature viscosity behavior. SPEs exhibit even lower thickening efficiency than that of PMAs and are prone to thermo-oxidative degradation but exhibit good low temperature properties. SPEs are used primarily in lubricant base stocks having higher polarity. PMA/OCP blends are used primarily with a polar solvent dispersant in lubricants to ensure that PMA remains the matrix phase whereas the OCP is the dispersed phase. PMA/OCP blends exhibit the same drawbacks as OCPs.

The only commercial di-block VMs currently available are in the SIP family with styrene-hydrogenated isoprene (hI) or styrene-hI-styrene linear block compositions. The styrene blocks have Mw ranging from 30K to 50K and the molecular weights of hI blocks range from 50K to 100K. These block VMs form micelles in paraffinic oils and in synthetic base stocks of PAOs. However, they do not form micelles in alkylated naphthalene (AN) base stocks or in some aromatic oils. With micelle formation, they function as associative thickeners with good thickening efficiency. Also, due to the ease which micelles break up under shear, they can exhibit earlier onset of shear thinning and good resistance to shear degradation. However, these block VMs are prone to thermo-oxidative degradation because of the polystyrene content and they still exhibit a negative temperature coefficient.

Conventional di-block viscosity modifiers that are micelle-forming in hydrocarbon solvent (or base stock) are based on di-block copolymers of polystyrene and poly(alternated ethylene-propylene). They were made by anionic living block co-polymerization of polyisoprene and polystyrene followed by hydrogenation. Hydrogenated polyisoprene is poly(alternated ethylene-propylene). Their molecular weights are greater than 100,000. Polystyrene is not soluble in lubricant base stocks and micelles are formed when these di-block copolymers are added into lubricant base stock with coiled polystyrene as the micelle core and coiled poly(alternated ethylene propylene) as the micelle corona. Through micelle formation by a di-block copolymer aggregation, its thickening efficiency is delivered through the big micelles instead of individual polymer coils. The micellization strength of polystyrene is not high to prevent the micelles from desegregating at high shear rates so that shear thinning can be achieved in using these di-block copolymer viscosity modifiers in lubricant solution. Although these di-block viscosity modifiers are used commercially, such as SV140 (ShellVis 140 from Infineum) of 130,000 molecular weight, they have two major deficiencies that need to be addressed. Both polystyrene micelle core and poly(alternating ethylene-propylene) micelle corona contract as opposed to expand with temperature, which could not improve the VI (viscosity index, or a measurement of the temperature coefficient of viscosity). Additionally, their molecular weights are preferred to be less than 100,000, most preferably less than 80,000, to prevent their shear degradation by chain scission. Since the scission stress at the center of a polymer chain is proportional to the molecular weight to the second power, for a viscosity modifier that has a molecular weight less than 60,000, we found that the shear degradation of a viscosity modifier in a lubricant solution may not occur. However, one cannot lower the molecular weight of the conventional di-block simply since it would shrink the micelles and would not deliver the necessary thickening efficiency.

WO2014/105290 A1 discloses alternating block copolymer having an olefin polymer block and a poly(alkyl methacrylate) block. The olefin polymer block has monomeric units of one or more alpha olefins of 2 to 12 carbon atoms that make up 90 wt % or more of the total weight of the olefin polymer block. The olefin polymer block exhibits a number average molecular weight from 1,000 to 500,000. The poly (alkyl methacrylate) block has monomeric units of one or more alkyl methacrylates with alkyl side chains of 1 to 100 carbon atoms that make up 90 wt % or more of the total weight of the poly(alkyl methacrylate) blocks. The poly(alkyl methacrylate) block exhibits a number average molecular weight in a range from 1,000 to 500,000. The alternating block copolymer in this reference has the capability to form micelles in hydrocarbon lubricant base stocks, which include cores formed from poly(alkyl methacrylate) and coil coronas formed from polyolefin. While the alternating block copolymers disclosed in this reference can be used as viscosity improver, viscosity improvement efficiency of them can be improved.

### SUMMARY

In a surprising manner, it has been found that a block copolymer comprising a polyalpha-olefin block derived from alpha-olefin monomer(s) having a carbon backbone comprising more than six (6) carbon atoms, and a poly(alkyl methacrylate) block derived from alkyl methacrylate monomer(s) where the alkyl group comprises at least six (6) carbon atoms exhibit particularly advantageous rheological properties compared to those already known in hydrocarbon solvents and/or lubricant base stocks: high thickening efficiency at room temperature, low shear-thinning onset shear rate, and broad shear-thinning shear rate range, which are particularly desirable for viscosity modifiers for lubricant oil compositions, even when the block copolymer has an overall molecular weight significantly lower than those viscosity modifiers already known.

Thus, a first aspect of this disclosure relates to block copolymer comprising: an alpha-olefin polymer block (“PAO block”) derived from one or more alpha-olefin monomer comprising more than 6 carbon atoms per molecule, the PAO block comprising a component represented by the structure within the brackets (“[ ]”) of the following formula (F-I):

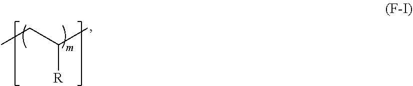

wherein each R, the same or different at each occurrence in the respective structural unit, is independently an alkyl group having a carbon backbone comprising at least five (5) carbon atoms, and m is an integer equal to or greater than 5; and an alkyl methacrylate polymer block (“PAMA block”) derived from one or more alkyl methacrylate monomer, the PAMA block comprising a component represented by the structure within the brackets (“[ ]”) of the following formula (F-II):

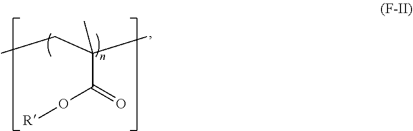

wherein each R′, the same or different at each occurrence in the respective structural unit, is independently an alkyl group comprising at least 6 carbon atoms, and n is an integer equal to or greater than 10.

A second aspect of this disclosure relates to a lubricant oil composition viscosity modifier comprising a block copolymer of the first aspect of this disclosure.

A third aspect of this disclosure relates to a lubricant oil composition comprising a block copolymer of the first aspect of this disclosure, or a viscosity modifier of the second aspect of this disclosure.

A third aspect of this disclosure relates to a process for making a block copolymer of the first aspect of this disclosure, comprising: polymerizing one or more linear alpha olefin monomer having more than six carbon atoms per molecule in the presence of a coordination insertion polymerization catalyst system to obtain an oligomerization reaction mixture; obtaining an alpha-olefin polymer mixture olefin (“PAO olefin”) comprising vinyl, vinylidene and/or tri-substituted olefins from the oligomerization reaction mixture; reacting the PAO olefin with an ATRP agent to obtain a macro radical polymerization initiator comprising a component corresponding to the PAO olefin; mixing the macro radical polymerization initiator with an alkyl methacrylate monomer having the following formula:

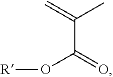

wherein the R′ group is an alkyl group comprising at least 6 carbon atoms; and initiating ATRP polymerization of the alkyl methacrylate monomer under ATRP polymerization conditions to obtain a polymerization reaction mixture comprising a block copolymer comprising a block corresponding to the PAO olefin (“PAO block”) and a block derived from the alkyl methacrylate monomer.

### BRIEF DESCRIPTION OF THE DRAWINGS

FIG. 1 is a diagram showing the rheological behavior of a commercial viscosity modifier in a PAO base stock.

FIG. 2 is a diagram showing the rheological behavior of a di-block copolymer prepared in Example D in PAO-4 base stock.

FIG. 3 is a diagram showing the rheological behavior of a di-block copolymer prepared in Example C in PAO-4 base stock.

FIG. 4 is a diagram showing the rheological behaviors of a commercial viscosity modifier, a di-block copolymer prepared in Example C, and a di-block copolymer prepared in Example D, in PAO-4 base stock.

FIG. 5 is a diagram showing the rheological behaviors of a commercial viscosity modifier, an atactic polypropylene polymer, an atactic polypropylene/polyoctyldecyl methacrylate di-block copolymer, an atactic polypropylene/polybutyl methacrylate di-block copolymer, described in comparative Example F, in PAO-4 base stock.

### DETAILED DESCRIPTION

The term “alkyl” or “alkyl group” interchangeably refers to a saturated hydrocarbyl group consisting of carbon and hydrogen atoms. An alkyl group can be linear, branched linear, cyclic, or substituted cyclic where the substitute is an alkyl.

The term “hydrocarbyl group” or “hydrocarbyl” interchangeably refers to a group consisting of hydrogen and carbon atoms only. A hydrocarbyl group can be saturated or unsaturated, linear or branched linear, cyclic or acyclic, aromatic or non-aromatic.

The term “alkyl methacrylate” refers to a compound having the following structure:

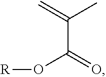

wherein R is an alkyl group.

The term “Cn” group, compound or oligomer refers to a group, a compound or an oligomer comprising carbon atoms at total number thereof of n. Thus, a “Cm-Cn” group, compound or oligomer refers to a group, compound or oligomer comprising carbon atoms per group or molecule at a total number thereof in a range from m to n. Thus, a C28-C32 oligomer refers to an oligomer comprising carbon atoms per molecule at a total number thereof in a range from 28 to 32.

The term “carbon backbone” refers to the longest straight carbon chain in the molecule of a compound, group or oligomer in question. “Branch” refers to any non-hydrogen group connected to the carbon backbone.

The term “olefin” refers to an unsaturated hydrocarbon compound having a hydrocarbon chain containing at least one carbon-to-carbon double bond in the structure thereof, wherein the carbon-to-carbon double bond does not constitute a part of an aromatic ring. The olefin may be linear, branched linear, or cyclic. “Olefin” is intended to embrace all structural isomeric forms of olefins, unless it is specified to mean a single isomer or the context clearly indicates otherwise.

The term “alpha-olefin” refer to an olefin having a terminal carbon-to-carbon double bond in the structure thereof ((R¹R²)—C═CH₂, where R¹ and R² can be independently hydrogen or any hydrocarbyl group, preferably R¹ is hydrogen, and R² is an alkyl group). A “linear alpha-olefin” is an alpha-olefin defined in this paragraph wherein R¹ is hydrogen, and R² is hydrogen or a linear alkyl group.

The term “vinyl” means an olefin having the following formula:

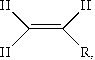

wherein R is a hydrocarbyl group, preferably a saturated hydrocarbyl group such as an alkyl group.

The term “vinylidene” means an olefin having the following formula:

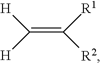

wherein R¹ and R² are each independently a hydrocarbyl group, preferably a saturated hydrocarbyl group such as alkyl group.

The term “1,2-di-substituted vinylene” means

(i) an olefin having the following formula:

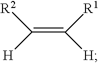

or

(ii) an olefin having the following formula:

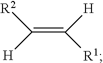

or

(iii) a mixture of (i) and (ii) at any proportion thereof,

wherein R¹ and R², the same or different at each occurrence, are each independently a hydrocarbyl group, preferably saturated hydrocarbyl group such as alkyl group.

The term “tri-substituted vinylene” means an olefin having the following formula:

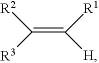

wherein R¹, R², and R³ are each independently a hydrocarbyl group, preferably a saturated hydrocarbyl group such as alkyl group.

The term “tetra-substituted vinylene” means an olefin having the following formula:

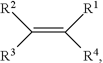

wherein R¹, R², R³ and R⁴ are each independently a hydrocarbyl group, preferably a saturated hydrocarbyl group such as alkyl group.

As used herein, “polyalpha-olefin(s)” (“PAO(s)”) includes any oligomer(s) and polymer(s) of one or more alpha-olefin monomer(s). PAOs are oligomeric or polymeric molecules produced from the polymerization reactions of alpha-olefin monomer molecules in the presence of a catalyst system, optionally further hydrogenated to remove residual carbon-carbon double bonds therein. Thus, the PAO can be a dimer, a trimer, a tetramer, or any other oligomer or polymer comprising two or more structure units derived from one or more alpha-olefin monomer(s). The PAO molecule can be highly regio-regular, such that the bulk material exhibits an isotacticity, or a syndiotacticity when measured by ¹³C NMR. The PAO molecule can be highly regio-irregular, such that the bulk material is substantially atactic when measured by ¹³C NMR. A PAO material made by using a metallocene-based catalyst system is typically called a metallocene-PAO (“mPAO”), and a PAO material made by using traditional non-metallocene-based catalysts (e.g., Lewis acids) is typically called a conventional PAO (“cPAO”).

The term “pendant group” with respect to a PAO molecule refers to any group other than hydrogen attached to the carbon backbone other than those attached to the carbon atoms at the very ends of the carbon backbone.

The term “length” of a pendant group is defined as the total number of carbon atoms in the longest carbon chain in the pendant group, counting from the first carbon atom attached to the carbon backbone. The pendant group may contain a cyclic group or a portion thereof in the longest carbon chain, in which case half of the carbon atoms in the cyclic group are counted toward the length of the pendant group. Thus, by way of examples, a linear C8 pendant group has a length of 8; the pendant groups PG-1 (cyclohexylmethylene) and PG-2 (phenylmethylene) each has a length of 4; and the pendant groups PG-3 (o-heptyl-phenylmethylene) and PG-4 (p-heptylphenylmethylene) each has a length of 11. Where a PAO molecule contains multiple pendant groups, the arithmetic average of the lengths of all such pendant groups are calculated as the average length of the all pendant groups in the PAO molecule.

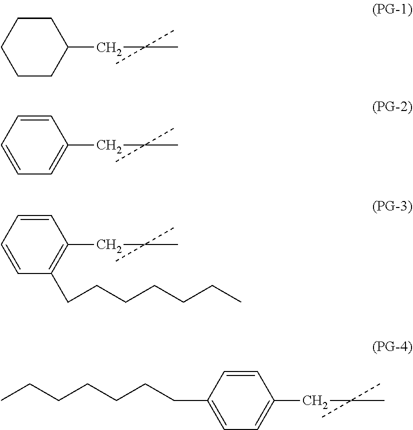

The term “bottle-brush polymer component” means a polymer component represented by the structure within the brackets (“[ ]”) of the following formula:

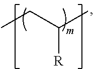

wherein each R, the same or different at each occurrence in the respective structural unit, is independently an alkyl group having a carbon backbone comprising at least five (5) carbon atoms, and m is an integer of at least five (5). A polymer consisting essentially of bottle-brush polymer component(s) is called a “bottle-brush polymer.”

Unless specified otherwise, the term “substantially all” with respect to PAO molecules means at least 90 mol % (such as at least 95 mol %, at least 98 mol %, at least 99 mol %, or even 100 mol %).

Unless specified otherwise, the term “consist essentially of” means comprising at a concentration of at least 90 wt % (such as at least 95 wt %, at least 98 wt %, at least 99 wt %, or even 100 wt %).

Unless specified otherwise, the term “substantially free of” with respect to a particular component means the concentration of that component in the relevant composition is no greater than 10 wt % (such as no greater than 5 wt %, no greater than 3 wt %, or no greater than 1 wt %), based on the total quantity of the relevant composition.

As used herein, a “lubricant” refers to a substance that can be introduced between two or more moving surfaces and lower the level of friction between two adjacent surfaces moving relative to each other. A lubricant “base stock” is a material, typically a fluid at the operating temperature of the lubricant, used to formulate a lubricant by admixing it with other components. Non-limiting examples of base stocks suitable in lubricants include API Group I, Group II, Group III, Group IV, and Group V base stocks. Fluids derived from Fischer-Tropsch process or Gas-to-Liquid (“GTL”) processes are examples of synthetic base stocks useful for making modern lubricants. Description of GTL base stocks and processes for making them can be found in, e.g., WO 2005/121280 A1 and U.S. Pat. Nos. 7,344,631; 6,846,778; 7,241,375; and 7,053,254.

All kinematic viscosity values in this disclosure are as determined according to ASTM D445. Kinematic viscosity at 100° C. is reported herein as KV100, and kinematic viscosity at 40° C. is reported herein as KV40. Unit of all KV100 and KV40 values herein is cSt, unless otherwise specified.

All viscosity index (“VI”) values in this disclosure are as determined according to ASTM D2270.

All high-temperature high-shear viscosity (“HTHSV”) values in this disclosure are as determined pursuant to ASTM D4683. Unit of HTHSV values is centipoise, unless otherwise specified.

All numerical values within the detailed description and the claims herein are modified by “about” or “approximately” the indicated value, and taking into account experimental error and variations that would be expected by a person having ordinary skill in the art.

In this disclosure, all percentages of pendant groups, terminal carbon chains, and side chain groups are by mole, unless specified otherwise. Percent by mole is expressed as “mol %,” and percent by weight is expressed as “wt %.”

Molecular weights (number average molecular weight (Mn), weight average molecular weight (Mw), and z-average molecular weight (Mz)) are determined using a Polymer Laboratories Model 220 room temperature GPC-SEC (gel permeation—size exclusion chromatograph) equipped with on-line differential refractive index (DRI) detector. It uses three Polymer Laboratories PLgel 10 m Mixed-B columns for separation using a flow rate of 0.54 ml/min and a nominal injection volume of 300 microliter. The detectors and columns were contained at room temperature. The stream emerging from the SEC columns was directed into the DRI detector. The DRI detector was an integral part of the Polymer Laboratories SEC. The details of these detectors as well as their calibrations have been described by, for example, T. Sun et al., in Macromolecules, Volume 34, Number 19, pp. 6812-6820, (2001), which is incorporated herein by reference.

Solvent for the GPC-SEC was prepared by dissolving 6 grams of butylated hydroxy toluene (BHT) as an antioxidant in 4 liters of Aldrich reagent grade 1, 2, 4-trichlorobenzene (TCB). The TCB mixture was then filtered through a 0.7 micrometer glass pre-filter and subsequently through a 0.1 micrometer Teflon filter. The TCB was then degassed with an online degasser before entering the SEC. Polymer solutions were prepared by placing dry polymer in a glass container, adding the desired amount of BHT stabilized TCB. All quantities were measured gravimetrically. The TCB densities used to express the polymer concentration in mass/volume units are 1.463 g/mL at 22° C. The injection concentration was from 1.0 to 2.0 mg/mL, with lower concentrations being used for higher molecular weight samples. Prior to running each sample the DRI detector and the injector were purged. Flow rate in the apparatus was then increased to 0.5 mL/minute, and the DRI is allowed to stabilize for 8 to 9 hours before injecting the first sample. The concentration, c, at each point in the chromatogram is calculated from the baseline-subtracted DRI signal, I_{DRI}, using the following equation:

$$c = {K}_{DRI} {I}_{DRI} / ( \frac{dn}{d c} ) ,$$

where K_{DRI} is a constant determined by calibrating the DRI with a series of mono-dispersed polystyrene standards with molecular weight ranging from 600 to 10M, and (dn/dc) is the refractive index increment for the system. Unit of molecular weight in this disclosure is gram·mole⁻¹. The polydispersity index (PDI) of the material is then calculated as follows:

PDI=Mw/Mn.

NMR spectroscopy provides key structural information about the synthesized polymers. Proton NMR (¹H-NMR) analysis of the unsaturated PAO material gives a quantitative breakdown of the olefinic structure types (viz. vinyl, 1,2-di-substituted vinylene, tri-substituted vinylene, and vinylidene). In this disclosure, compositions of mixtures of olefins comprising terminal olefins (vinyls and vinylidenes) and internal olefins (1,2-di-substituted vinylenes and tri-substituted vinylenes) are determined by using ¹H-NMR. Specifically, a NMR instrument of at least 500 MHz is run under the following conditions: a 30° flip angle RF pulse, 120 scans, with a delay of 5 seconds between pulses; sample dissolved in CDCl₃ (deuterated chloroform); and signal collection temperature at 25° C. The following approach is taken in determining the concentrations of the various olefins among all of the olefins from an NMR spectrum. First, peaks corresponding to different types of hydrogen atoms in vinyls (T1), vinylidenes (T2), 1,2-di-substituted vinylenes (T3), and tri-substituted vinylenes (T4) are identified. Second, areas of each of the above peaks (A1, A2, A3, and A4, respectively) are then integrated. Third, quantities of each type of olefins (Q1, Q2, Q3, and Q4, respectively) in moles are calculated (as A1/2, A2/2, A3/2, and A4, respectively). Fourth, the total quantity of all olefins (Qt) in moles is calculated as the sum total of all four types (Qt=Q1+Q2+Q3+Q4). Finally, the molar concentrations (C1, C2, C3, and C4, respectively, in mol %) of each type of olefin, on the basis of the total molar quantity of all of the olefins, is then calculated (in each case, Ci=100*Qi/Qt).

In this disclosure, a process is described as comprising at least one “step.” It should be understood that each step is an action or operation that may be carried out once or multiple times in the process, in a continuous or discontinuous fashion. Unless specified to the contrary or the context clearly indicates otherwise, the steps in a process may be conducted sequentially in the order as they are listed, with or without overlapping between one or more other step(s), or in any other order, as the case may be. In addition, one or more or even all steps may be conducted simultaneously with regard to the same or different batch of material. For example, in a continuous process, while a first step in a process is being conducted with respect to a raw material just fed into the beginning of the process, a second step may be carried out simultaneously with respect to an intermediate material resulting from treating the raw materials fed into the process at an earlier time in the first step. Preferably, the steps are conducted in the order described.

As used herein, the indefinite article “a” or “an” shall mean “at least one” unless specified to the contrary or the context clearly indicates otherwise. Thus, embodiments using “a monomer” include embodiments where one, two or more such monomers is used, unless specified to the contrary or the context clearly indicates that only one such monomer is used.

Unless otherwise indicated, all numbers indicating quantities in this disclosure are to be understood as being modified by the term “about” in all instances. It should also be understood that the precise numerical values used in the specification and claims constitute specific embodiments. Efforts have been made to ensure the accuracy of the data in the examples. However, it should be understood that any measured data inherently contain a certain level of error due to the limitation of the technique and equipment used for making the measurement.

In this disclosure, block copolymers are prepared that are micelle-forming, associative thickeners and exhibit one or more of excellent thickening efficiency, shear stability, thermo-oxidative stability, favorable low temperature properties, early shear thinning onset, and positive temperature coefficient. The block copolymers are suitable for improving the viscometric behavior of lubricants.

The block copolymers have an alpha-olefin polymer block (“PAO block”) and an alkyl methacrylate polymer block (“PAMA block”). The PAO block is miscible in hydrocarbon solvents and hydrocarbon-based lubricant base stocks. The PAMA block is immiscible in hydrocarbon solvent and hydrocarbon-based lubricant base stocks. The miscibility of the PAO block and the immiscibility of the PAMA block together impart the exceptional micelle/vesicle formation capability of the block copolymer of this disclosure in hydrocarbon solvent and/or hydrocarbon-based lubricant base stocks. The micelle/vesicle formation provides exceptional thickening capability, provides earlier onset of shear thinning, and minimizes shear degradation.

### I. The PAO Block

The PAO block comprises structural units derived from at least one alpha-olefin monomer comprising more than 6 carbon atoms per molecule, such as alpha-olefins comprising 7, 8, 9, 10, 11, 12, 13, 14, 15, 16, 17, 18, 19, 20, 21, 22, 23, 24, 25, 26, 27, 28, 29, or 30 carbon atoms per molecule. Preferably, the PAO block comprises structural units derived from at least one alpha-olefin monomer comprising 7, 8, 9, 10, 12, 14, 16, 18, 20, 22, 24, 26, 28, or 30 carbon atoms per monomer molecule. More preferably, the PAO comprises structural units derived from at least one alpha-olefin monomer comprising 8, 10, 12, 14, 16, 18, 20, 22, or 24 carbon atoms per monomer molecule.

Preferably, the PAO block comprises structural units derived only from linear alpha-olefins. More preferably, the PAO base stock comprises structural units derived only from at least one linear alpha-olefin monomers comprising 7, 8, 9, 10, 12, 14, 16, 18, 20, 22, 24, 26, 28, or 30 carbon atoms per monomer molecule. Still more preferably, the PAO block comprises structural units derived only from at least one linear alpha-olefin monomer comprising 8, 10, 12, 14, 16, 18, 20, 22, or 24 carbon atoms per monomer molecule.

The PAO block may be prepared by the oligomerization of a single olefin monomer or co-oligomerization of two or more olefin monomers. When the PAO block is prepared from the oligomerization of two or more olefin monomers, they may comprise the same or different number of carbon atoms; and preferably all of them comprise more than 6 carbon atoms in their molecular structures, and more preferably all of them comprise 7, 8, 9, 10, 12, 14, 16, 18, 20, 22, 24, 26, 28, or 30 carbon atoms per monomer molecule, and still more preferably all of them comprise 8, 10, 12, 14, 16, 18, 20, 22, or 24 carbon atoms per monomer molecule.

The PAO block comprises a structural component represented by the structure within the brackets (“[ ]”) of the following formula (F-I) (“component of (F-I)”):

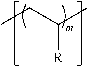

(F-I), wherein each pendant group R, the same or different at each occurrence in the respective unit, is independently a linear alkyl group having more than 4 carbon atoms, and m is an integer equal to or greater than 5.

In (F-I), preferably each R, the same or different at each occurrence in the respective unit, is independently an alkyl group (preferably a linear alkyl group) having a carbon backbone comprising 5, 6, 7, 8, 9, 10, 11, 12, 13, 14, 15, 16, 17, 18, 19, 20, 21, 22, 23, 24, 25, 26, 27, or 28 carbon atoms. More preferably, each R, the same or different at each occurrence in the respective unit, is independently an alkyl group (preferably a linear alkyl group) having a carbon backbone comprising 5, 6, 7, 8, 10, 12, 14, 16, 18, 20, 22, 24, 26, or 28 carbon atoms. More preferably, each R, the same or different at each occurrence in the respective unit, is independently an alkyl group (preferably a linear alkyl group) having a carbon backbone comprising 6, 8, 10, 12, 14, 16, 18, 20, 22, 24, 26, or 28 carbon atoms.

In formula (F-I), the integer m can be preferably in a range from m1 to m2, where m1 and m2 can be, independently, 5, 6, 7, 8, 9, 10, 20, 30, 40, 50, 60, 70, 80, 90, 100, 120, 140, 150, 160, 180, 200, 220, 240, 250, 260, 180, or 300, as long as m1<m2.

The PAO block of the copolymer of this disclosure preferably has a number average molecular weight in a range from Mn1 to Mn2 grams·mole⁻¹, where Mn1 and Mn2 can be, independently, 1,000, 2,000, 3,000, 4,000, 5,000, 6,000, 7,000, 8,000, 9,000, 10,000, 12,000, 15,000, 16,000, 18,000, 20,000, 22,000, 24,000, 25,000, 26,000, 28,000, 30,000, 35,000, 40,000, 45,000, or 50,000, as long as Mn1<Mn2. Preferably Mn1=2,000 and Mn2=40,000. More preferably Mn1=3,000 and Mn2=30,000. Still more preferably Mn1=5,000 and Mn2=20,000. In case the PAO block is derived from a PAO olefin (described below), the molecular weight and molecular weight distribution of the PAO block can be obtained by measuring the molecular weight of the PAO olefin using GPC.

Preferably, the PAO block may comprise a single or multiple component(s) of (F-I). It is preferred that components represented by (F-I) constitute a majority, more preferred at least 60 wt %, still more preferably at least 70 wt %, still more preferably at least 80 wt %, still more preferably at least 90 wt %, still more preferably at least 95 wt %, still more preferably at least 97 wt %, still more preferably at least 98 wt %, of the PAO block, based on the total weight of the PAO block. Between any two adjacent components of (F-I), structural components derived from olefin monomers not represented by (F-I) may exist. Total quantity of such structural components in the PAO block not represented by formula (F-I) described above is desirably less than 50 wt %, preferably less than 40 wt %, more preferably less than 30 wt %, still more preferably less than 20 wt %, still more preferably less than 10 wt %, still more preferably less than 5 wt %, still more preferably less than 3 wt %, still more preferably less than 2 wt %, based on the total weight of the PAO block.

The PAO structure component of (F-I) described above where each R, the same or different at each occurrence in the respective unit, in independently a linear alkyl group having at least 5 carbon atoms is a bottle-brush PAO structure component. Without intending to be bound by a particular theory, it is believed that due to the length of the R (comprising a carbon backbone having at least 5 carbon atoms) and the short distance between adjacent R groups (2 carbon atoms on the carbon backbone of the PAO structure component between them), the backbone of the PAO structure component of (F-I) tend to extend substantially fully as a result of the interaction between adjacent R groups, when the PAO block is placed in a hydrocarbon solvent or lubricant base stock, forming a rigid structure similar to a bottle brush. A PAO block comprising primarily structural components of (F-I) can behave like a bottle brush polymer in a hydrocarbon solvent or a hydrocarbon-based lubricant oil base stock. Without intending to be bound by a particular theory, it is believed that the bottle brush structure of the PAO structure component in the PAO block in the block copolymer of this disclosure contributes partly to the unique rheological behavior of the copolymer in hydrocarbon solvent and hydrocarbon-based lubricant base stocks.

Conversely, in a comparative PAO structure component not represented by formula (F-I) described above, such as those structure components having a formula (F-I) but with the exception that R can be hydrogen, methyl, ethyl, n-propyl, or n-butyl, because the pendent group R is short, the carbon backbone tend to bend and coil—as opposed to extend substantially fully—when placed in a hydrocarbon medium. It is known that conventional PAO materials, i.e., PAO materials made by oligomerization of alpha-olefin monomer(s) in the presence of Lewis acid catalysts such as BF3 and AlCl3, tend to comprise large proportions of such comparative structure components as a result of monomer isomerization and cationic rearrangements by hydride and methide shifts (C. Corno, G. Ferraris, A. Priola, and S. Cesca, “On the Cationic Polymerization of Olefins and the Structure of the Product Polymers. 2. Poly-1-butene”, Macromolecules, Volume 12, (1979), 404-411), leading to irregular spacing between side chains and irregular side chain lengths. The result is that a conventional PAO made by cationic oligomerization has a comb structure instead of a bottle brush structure.

The PAO block in the block copolymer of this disclosure can be desirably saturated, i.e., free of C═C and C≡C bonds in its molecular structure.

The PAO block can be advantageously made by the oligomerization of at least one olefin by coordination insertion polymerization in the presence of a catalyst system, such as a Ziegler-Natta catalyst system or a catalyst system comprising a metallocene compound, described below.

### II. The PAMA Block

The PAMA block in the block copolymer of this disclosure comprises structure units derived from an alkyl methacrylate monomer having the following structure of formula (F-AMA):

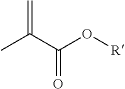

(F-AMA), wherein the alkyl group R′ comprises at least 6 carbon atoms. Preferably, the alkyl group R′ comprises 6, 7, 8, 9, 10, 11, 12, 13, 14, 15, 16, 17, 18, 19, 20, 21, 22, 23, 24, 25, 26, 27, 28, 29, or 30 carbon atoms. More preferably, the alkyl group R′ comprises 6, 7, 8, 9, 10, 12, 14, 16, 18, 20, 22, 24, 26, 28, or 30 carbon atoms. Still more preferably, the alkyl group R′ comprises 6, 8, 10, 12, 14, 18, 20, 22, 24, 26, 28, or 30 carbon atoms. Preferably, the alkyl group R′ has a carbon backbone comprising 6, 7, 8, 9, 10, 11, 12, 13, 14, 15, 16, 17, 18, 19, 20, 21, 22, 23, 24, 25, 26, 27, 28, 29, or 30 carbon atoms. More preferably, the alkyl group R′ has a carbon backbone comprising 6, 7, 8, 9, 10, 12, 14, 16, 18, 20, 22, 24, 26, 28, or 30 carbon atoms. Still more preferably, the alkyl group R′ has a carbon backbone comprising 6, 8, 10, 12, 14, 18, 20, 22, 24, 26, 28, or 30 carbon atoms.

The PAMA block may be derived from one or more alkyl methacrylate monomer(s). When the PAMA block is prepared from the oligomerization of two or more alkyl methacrylate monomers, the monomers may comprise the same or different number of carbon atoms; and preferably all of them comprise alkyl group R's comprising at least 6 carbon atoms, and more preferably all of them comprise alkyl group R's comprising 7, 8, 9, 10, 12, 14, 16, 18, 20, 22, 24, 26, 28, or 30 carbon atoms, and still more preferably all of them comprise alkyl group R's comprising 8, 10, 12, 14, 16, 18, 20, 22, or 24 carbon atoms; preferably all of them comprise alkyl group R's having a carbon backbone comprising at least 6 carbon atoms, and more preferably all of them comprise alkyl group R's having a carbon backbone comprising 7, 8, 9, 10, 12, 14, 16, 18, 20, 22, 24, 26, 28, or 30 carbon atoms, and still more preferably all of them comprise alkyl group R's having a carbon backbone comprising 8, 10, 12, 14, 16, 18, 20, 22, or 24 carbon atoms.

The PAMA block preferably comprises a structural component represented by the structure within the brackets (“[ ]”) of the following formula (F-II):

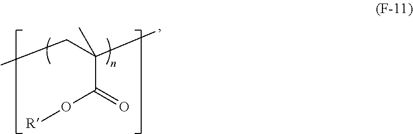

wherein each R′, the same or different at each occurrence in the respective unit, independently represents an alkyl comprising at least 6 carbon atoms, and n is an integer equal to or greater than 10.

In (F-II), preferably each R′, the same or different at each occurrence in the respective unit, is independently an alkyl group (preferably a linear or branched linear group) comprising 6, 7, 8, 9, 10, 11, 12, 13, 14, 15, 16, 17, 18, 19, 20, 21, 22, 23, 24, 25, 26, 27, or 28 carbon atoms. More preferably, each R′, the same or different at each occurrence in the respective unit, is independently an alkyl group (preferably a linear or branched alkyl group) comprising 6, 7, 8, 10, 12, 14, 16, 18, 20, 22, 24, 26, or 28 carbon atoms. More preferably, each R′, the same or different at each occurrence in the respective unit, is independently an alkyl group (preferably a linear or branched linear alkyl group) comprising 6, 8, 10, 12, 14, 16, 18, 20, 22, 24, 26, or 28 carbon atoms.

In (F-II), preferably each R′, the same or different at each occurrence in the respective unit, is independently an alkyl group (preferably a linear or branched linear group) having a carbon backbone comprising 6, 7, 8, 9, 10, 11, 12, 13, 14, 15, 16, 17, 18, 19, 20, 21, 22, 23, 24, 25, 26, 27, or 28 carbon atoms. More preferably, each R′, the same or different at each occurrence in the respective unit, is independently an alkyl group (preferably a linear or branched alkyl group) having a carbon backbone comprising 6, 7, 8, 10, 12, 14, 16, 18, 20, 22, 24, 26, or 28 carbon atoms. More preferably, each R′, the same or different at each occurrence in the respective unit, is independently an alkyl group (preferably a linear or branched linear alkyl group) having a carbon backbone comprising 6, 8, 10, 12, 14, 16, 18, 20, 22, 24, 26, or 28 carbon atoms.

In formula (F-II), the integer n can be preferably in a range from n1 to n2, where n1 and n2 can be, independently, 10, 20, 30, 40, 50, 60, 70, 80, 90, 100, 120, 140, 150, 160, 180, 200, 220, 240, 250, 260, 180, 300, 320, 340, 350, 360, 380, 400, 420, 440, 450, 460, 480, or 500, as long as n1<n2.

The PAMA block of the block copolymer of this disclosure desirably has a number average molecular weight in a range from Mn3 to Mn4 grams·mole⁻¹, where Mn3 and Mn4 can be, independently, 1,000, 2,000, 3,000, 4,000, 5,000, 6,000, 7,000, 8,000, 9,000, 10,000, 12,000, 15,000, 16,000, 18,000, 20,000, 22,000, 24,000, 25,000, 26,000, 28,000, or 30,000, as long as Mn3<Mn4. In general, the higher the number-average molecular weight of the PAMA block, the higher the polarity of the PAMA block and the stronger the micelle core formed, and the more difficult to shear apart the micelle core. At a number average molecular weight higher than 30,000, the PAMA blocks of the block copolymer of this disclosure tend to form micelle cores that are so strong that they cannot be sheared apart unless and until an extremely high shear rate is reached, which is not desirable for a viscosity improver of a lubricant oil composition.

In case the PAMA block of the block copolymer is formed by polymerization of alkyl methacrylate monomer(s) initiated from a macromolecular moiety comprising the PAO block (e.g., by the ATRP route described below), the molecular weight of the block copolymer can be measured directly using GPC. The number average molecular weight of the PAMA block can be calculated by subtracting the number average molecular weight of the PAO block and the molecular weight of the linking group, if any, from the number average molecular weight of the block copolymer.

The PAMA block in the block copolymer of this disclosure is advantageously formed by controlled radical polymerization of one or more alkyl methacrylate monomer(s) in the presence of a catalyst under controlled radical polymerization conditions.

Preferably the PAMA block in the block copolymer of this disclosure is fabricated by an atom-transfer radical polymerization (“ATRP”) process, a reversible addition/fragmentation chain transfer polymerization (“RAFT”) process, or a nitroxide mediated polymerization (“NMP”) process. Detailed description of the ATRP, RAFT, and NMP processes are provided in, e.g., Controlled Radical Polymerization Guide, ATRP, RAFT, NMP, by Sigma Aldrich (2012), the contents of which are incorporated herein by reference in its entirety. In an ATRP process, a PAO block is first converted into a macro initiator, which contacts alkyl methacrylate monomer, and initiates the polymerization of the alkyl methacrylate monomer. The controlled radical polymerization of the alkyl methacrylate monomer proceeds until the termination of the polymerization forming a PAMA block connected to the PAO block. An advantage of the ATRP process is the high uniformity of the molecular weight of the PAMA blocks formed in the block copolymer molecules. The ATRP process will be described in greater detail and illustrated in the examples of this disclosure below.

### III. Linkage Between the PAO Block and the PAMA Block

In the block copolymer of this disclosure, the PAO block is linked covalently to the PAMA block via one or more covalent bonds or one or more linking groups. Thus, the PAO block may be connected to the PAMA block via a single chemical bond, such as a C—C bond. It is possible that the PAO block may be connected to the PAMA block via two or more chemical bonds such as C—C bonds.

Preferably the PAO block is connected to the PAMA block via one or more linking groups. An example of such linking group has a structure within the brackets (“[ ]”) of the following formula (F-III):

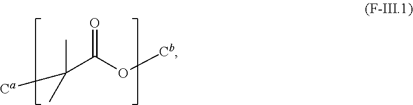

where C^{a} is a carbon atom in the PAMA block, and C^{b} is a carbon atom in the PAO block. This linking group can be introduced into the block copolymer structure via a chemical agent reactive with a pre-fabricated unsaturated PAO olefin to form a macromolecular free radical, which is capable of initiating controlled radical polymerization, more specifically, ATRP, of the alkyl methacrylate monomer to yield the PAMA block in the block copolymer of this disclosure.

Another example of the linking group has a structure within the brackets (“[ ]”) of the following formula (F-III.2):

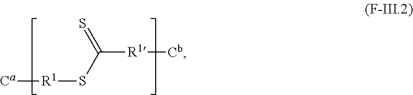

wherein: R¹ and R^{1′} are independently divalent hydrocarbyl groups (aliphatic, aromatic, or a combination of both) such as linear or branched alkylenes (e.g., methylene, ethylene, and the like), arylenes (phenylenes, naphthylenes, and the like), and alkylenearylenes (e.g., methylenephenylene, and the like); C^{a} is a carbon atom in the PAMA block; and C^{b} is a carbon atom in the PAO block. This linking group can be introduced into the block copolymer structure via a chemical agent reactive with a pre-fabricated unsaturated PAO olefin to form a macromolecular free radical, which is capable of initiating controlled radical polymerization, more specifically, RAFT process, of the alkyl methacrylate monomer to yield the PAMA block in the block copolymer of this disclosure.

Still another example of the linking group has a structure within the brackets (“[ ]”) of the following formula (F-III.3):

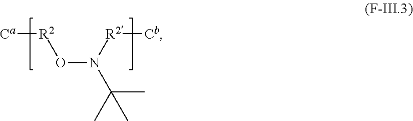

wherein: R² and R^{2′} are independently divalent hydrocarbyl groups (aliphatic, aromatic, or a combination of both) such as linear or branched alkylenes (e.g., methylene, ethylene, and the like), arylenes (phenylenes, naphthylenes, and the like), and alkylenearylenes (e.g., methylenephenylene, and the like); C^{a} is a carbon atom in the PAMA block; and C^{b} is a carbon atom in the PAO block. This linking group can be introduced into the block copolymer structure via a chemical agent reactive with a pre-fabricated unsaturated PAO olefin to form a macromolecular free radical, which is capable of initiating controlled radical polymerization, more specifically, NMP, of the alkyl methacrylate monomer to yield the PAMA block in the block copolymer of this disclosure.

Preferably the linkage such as the linking group between the PAO block and the PAMA block is introduced as part of the ATRP process. Thus, after a PAO material (preferably unsaturated and comprising a C═C bond in its molecular structure, preferably a vinyl, a vinylidene, or a tri-substituted olefin) is formed, the PAO material is allowed to react with a chemical agent to create a macro radical initiator, which converts the PAO material into the PAO block in the block copolymer of this disclosure, while introducing the linking group between the PAO block and the PAMA block. It is possible to use a chemical agent that yields a final linking group that is similar to a structural unit derived from radical polymerization of the alkyl methacrylate monomer. In such case the final block copolymer can be considered as formed from a PAO block and a PAMA block connected via a covalent bond.

A single linking group may connect a single PAO block to a single PAMA block. A single linking group may connect a single PAO block to two or more PAMA blocks.

The linking group, if present, has a molecular structure significantly smaller than the PAO block and the PAMA block. To that end, it is highly desired that molar mass of a linking group is no more than 500, preferably no more than 400, more preferably no more than 300, still more preferably no more than 200, still more preferably no more than 150, grams·mole⁻¹.

While it is possible that the PAO block and the PAMA block in the block copolymer of this disclosure may be connected by two or more linking groups each connecting a carbon atom in the PAO block to a carbon atom in the PAMA block, it is preferred that only one linking group exists in the block copolymer linking one carbon atom in the PAO block to one carbon atom in the PAMA block.

### IV. The Block Copolymer

Conventional block viscosity modifiers that are micelle-forming in hydrocarbon solvent (or base stock) are based on block copolymers of polystyrene (“PS”) and poly(alternated ethylene-propylene) (“PaEP”). They were made by anionic living block co-polymerization of polyisoprene and polystyrene followed by hydrogenation. Hydrogenated polyisoprene is poly(alternated ethylene-propylene). Their molecular weights are typically greater than 100,000. Polystyrene is not soluble in lubricant base stocks. Micelles are formed when these block copolymers are added into lubricant base stock with coiled polystyrene as the micelle core and coiled poly(alternated ethylene propylene) as the micelle corona. Through micelle formation by a block copolymer aggregation, its thickening efficiency is delivered through the big micelles instead of individual polymer coils. Because the carbon backbones of the PaEP blocks coil—as opposed to extend like rods—to form the corona in the micelle, the ability of the PS-PaEP block copolymer to form micelles having large volume depends on high molecular weight of the PaEP block, and the high molecular weight of the copolymer. The micellization strength of polystyrene is not high to prevent the micelles from desegregating at high shear rates so that shear thinning can be achieved in using these di-block copolymer viscosity modifiers in lubricant solution. Although these di-block viscosity modifiers are used commercially, such as SV140 (ShellVis 140 from Infineum) of 130,000 molecular weight, they have two major deficiencies that need to be addressed. Because both polystyrene micelle core and poly(alternating ethylene-propylene) micelle corona do not expand with temperature (and instead they contract), the PS-PaEP di-block copolymers do not improve VI. Additionally, their molecular weights are preferred to be less than 100,000, most preferably less than 80,000, to prevent their shear degradation by chain scission. Since the scission stress at the center of a polymer chain is proportional to the molecular weight to the second power, to avoid shear degradation of a viscosity modifier in a lubricant oil composition, the molecular weight of the viscosity modifier molecule should not be greater than 60,000. However, reducing the molecular weight of the PS-PaEP di-block copolymer to lower than 60,000 is undesirable for its performance as a viscosity modifier because doing so would reduce the overall micelle volume, thereby reducing the thickening efficiency.

The block copolymer of this disclosure comprises a PAO block and a PAMA block linked together through one or more covalent bond and/or one or more linking groups significantly smaller than either of the PAO and the PAMA blocks. The physical properties and behavior, particularly the rheological behavior in a hydrocarbon medium of the block copolymer of this disclosure, therefore, are largely determined by the PAO and the PAMA blocks.

The block copolymer of this disclosure can comprise a single PAO block and a single PAMA block, making it a di-block copolymer. The block copolymer of this disclosure may comprise a single PAO block linked to multiple PAMA blocks via covalent bonds and/or linking groups (fabricated by, e.g., using di-functional initiator for two PAMA blocks, tri-functional initiator for three PAMA blocks, and so on). Preferably, the block copolymer of this disclosure is a di-block copolymer.

PAMA blocks, due to their high polarity, are immiscible with a low-polarity hydrocarbon medium with low polarity at room temperature (e.g., 25° C.). Thus, without intending to be bound by a particular theory, it is believed that, in a hydrocarbon medium, the PAMA blocks of multiple block copolymer molecules of this disclosure tend to coil and coalesce to form a core structure of a micelle at low temperature such as room temperature.

PAO blocks, which are hydrocarbon components per se, are miscible with a hydrocarbon medium such as hydrocarbon lubricant base stocks. As a result, the PAO blocks of the multiple block copolymer molecules whose PAMA blocks coalesce to form a core tend not to coalesce in a hydrocarbon medium. Rather, they spread outward from the PAMA core into the hydrocarbon medium. The carbon backbones of the PAO blocks comprising primarily bottle-brush components extend and spread like multiple rods in the hydrocarbon medium. A bottle brush polymer has its carbon backbone fully extended and its molecular length is substantially equivalent to the length of its carbon backbone. A regular linear or comb polymer coils in the solvent and has its coil dimension proportional to the square root of its backbone length. Hence, for a bottle brush polymer comprising 100 monomer units, its length is about 100 times the monomer chain unit length; while for a linear polymer with 100 monomer units, its molecular length is about the square root of 100, which is 10, times the monomer chain unit length. Thus, multiple block copolymer of this disclosure can form a micelle comprising a PAMA core and a PAO corona formed by multiple rod-like bottle-brush structures in a hydrocarbon medium. The multiple-rod like PAO structures extending in multiple directions from the PAMA core can result in a micelle having large space volume, even if the individual block copolymer molecules do not have large molecular weight or molecular size. Large micelle space volume is believed to be conducive to high thickening efficiency of a viscosity improver. Thus, the block copolymer of this disclosure can form micelles with space volume significantly larger than micelles formed from a comparative block copolymer where the PAO block is a linear polymer or polymer obtained from conventional cationic polymerization having substantially the same polymer molecular weight.

Without intending to be bound by a particular theory, it is believed that the micelle-forming capability of the block copolymer of this disclosure and the unique micelle structure formed lead to interesting and useful behavior in a hydrocarbon medium such as a hydrocarbon solvent or hydrocarbon-based lubricant base stock, lending the block copolymer properties particularly desirable for a viscosity improver in lubricant formulations containing hydrocarbon base stocks.

In a surprising manner, it has been found that the block copolymer of this disclosure can have very high thickening efficiency even if the overall molecular weight of the copolymer is no higher than 80,000, 70,000, 60,000, 50,000, 40,000, 30,000, or even 20,000. Without intending to be bound by any theory, we believe this is due to the large micelle space volume resulting from the rod-like PAO blocks extending from the PAMA core. The relatively low overall molecular weight of the block copolymer of this disclosure translates to high shear stability thereof in a lubricant oil composition.

Conversely, in a comparative block copolymer comprising a PAO block and a PAMA block where the PAO block is a conventional PAO made by oligomerization of alpha-olefin monomer(s) in the presence of a Lewis acid catalyst as discussed above, the carbon backbone of the PAO block would coil rather than extend substantially fully like a rod in a hydrocarbon medium. Such comparative block copolymer molecules would form micelles in a hydrocarbon medium, but the resulting micelles tend to have smaller space volume compared to the micelles from the block copolymer of this disclosure.

It is known that PAMA coils in hydrocarbon medium can expand as the temperature increases. Thus, a coalesced group of PAMA molecules may become looser as temperature increases, and eventually disintegrate if the temperature is sufficiently high resulting in more even distribution of the PAMA in the hydrocarbon medium, especially in high-shear situations, provided that PAMA has alkyl carbon number greater than 6. If the poly(alkyl methacrylate) (PAMA), which is geminally substituted and is known to coil expand with temperature, is used as the micelle core block with the bottlebrush polymer block corona, then one would have a micelle-forming block copolymer viscosity modifiers with high thickening efficiency but at low molecular weight and shear stable while delivering high viscosity index, or low temperature coefficient of viscosity. We have found the poly(hexyl methacrylate) and other poly(alkyl methacrylate) with alkyl length less than 6, such as pentyl methacrylate, butyl methacrylate, propyl methacrylate, ethyl methacrylate, and methyl methacrylate, are so insoluble in hydrocarbon base stocks that the micellization strengths of the resulting micelles would be so strong that they cannot be sheared apart, or be sheared apart only at extremely high shear rates (e.g., up to 10⁹ s⁻¹ shear rate). In either case, these PAO-b-PAMA block copolymers cannot deliver shear thinning at low shear rates which is critical for a viscosity modifier to provide fuel economy to have shear thinning behavior so that low viscosity value can be attained at high shear rates (10⁵ s⁻¹ shear rate and above). Even using a PAMA block with alkyl length greater than 6 carbons, it is still preferred to keep the PAMA block molecular weight to be below 30,000 so to weaken the micellization allowing micelles to be broken down more easily at high shear rates.

The block copolymer of this disclosure preferably has an overall number average molecular weight in a range from Mn5 to Mn6 grams mole-1, where Mn5 and Mn6 can be, independently, 4,000, 5,000, 6,000, 7,000, 8,000, 9,000, 10,000, 15,000, 20,000, 25,000, 30,000, 35,000, 40,000, 45,000, 50,000, 55,000, 60,000, 65,000, 70,000, 75,000, or 80,000, as long as Mn5<Mn6. Preferably Mn5=5,000, and Mn6=60,000. More preferably Mn5=8,000, and Mn6=50,000. Compared to known block copolymers useful as viscosity improvers, the block copolymer of this disclosure achieves higher or similar thickening efficiency at lower overall number average molecular weight due to the extending PAO blocks. The relatively low overall number average molecular weight of the block copolymers of this disclosure also translates to high shear stability of the lubricant formulation containing them. The relatively low polarity of the PAMA blocks resulting from the large carbon numbers in the alkyl group in the monomer and the relatively low number average molecular weight of the PAMA blocks contributes to a low shear-thinning-onset shear rate.

### V. Process for Making the Block Copolymer

A preferred process for making the block copolymer of this disclosure includes the following steps:

(I) polymerizing one or more linear alpha olefin monomer having more than six carbon atoms per molecule in the presence of a coordination insertion polymerization catalyst system to obtain an oligomerization reaction mixture;

(II) obtaining an alpha-olefin polymer mixture olefin (“PAO olefin”) comprising vinyl, vinylidene and/or tri-substituted olefins from the oligomerization reaction mixture;

(III) reacting the PAO olefin with an ATRP agent to obtain a macro radical polymerization initiator comprising a component corresponding to the PAO olefin;

(IV) mixing the macro radical polymerization initiator with an alkyl methacrylate monomer having the following formula:

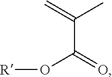

wherein the R′ group is an alkyl group having a carbon backbone comprising at least 6 carbon atoms; and

(V) initiating ATRP polymerization of the alkyl methacrylate monomer under ATRP polymerization conditions to obtain a polymerization reaction mixture comprising a block copolymer comprising a block corresponding to the PAO olefin (“PAO block”) and a block derived from the alkyl methacrylate monomer.

In step (I), the catalyst system can be a Ziegler-Natta catalyst or a catalyst system comprising a metallocene compound. In both cases, the catalyst system may further comprise an activator and/or a scavenger.

Many metallocene compounds known to one having ordinary skill in the art can be used. For example, many of the metallocene compounds disclosed in U.S. Pat. Nos. 9,409,834 B2 and 9,701,595 can be used, the relevant portions thereof are incorporated herein by reference. Particularly useful examples of metallocene compounds for making the unsaturated PAO material of the present disclosure have a structure of (MC-I) or (MC-II) below:

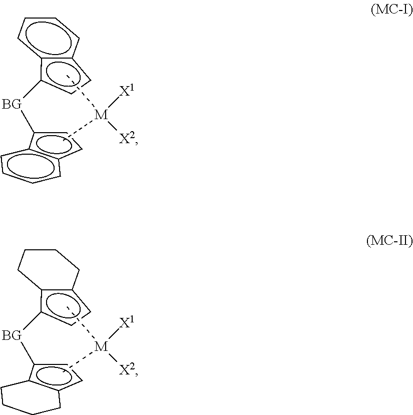

where M is Hf or Zr, X¹ and X², the same or different, are independently selected from halogens and C1-050 substituted or unsubstituted linear, branched, or cyclic hydrocarbyl groups, and -BG- is a bridging group selected from

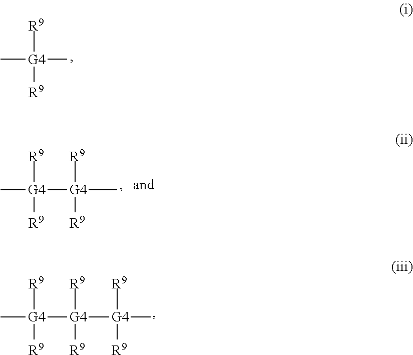

where groups G4 are, the same or different at each occurrence, independently selected from carbon, silicon, and germanium, and each R⁹ is independently a C1-C30 substituted or unsubstituted linear, branched, or cyclic hydrocarbyl groups. Preferred R⁹ includes substituted or unsubstituted methyl, ethyl, n-propyl, phenyl, and benzyl. Preferably -BG-is category (i) or (ii) above. More preferably -BG- is category (i) above. Preferably all R⁹'s are identical. Preferably G4 is silicon, and all R⁹ groups are methyl.

The metallocene compounds, when activated by a commonly known activator such as non-coordinating anion activator, form active catalysts for the polymerization or oligomerization of olefins. Activators that may be used include Lewis acid activators such as triphenylboron, tris-perfluorophenylboron, tris-perfluorophenylaluminum and the like and or ionic activators such as dimethylanilinium tetrakisperfluorophenylborate, triphenylcarboniumtetrakis perfluorophenylborate, dimethylaniliniumtetrakisperfluorophenylaluminate, and the like.

A co-activator is a compound capable of alkylating the transition metal complex, such that when used in combination with an activator, an active catalyst is formed. Co-activators include alumoxanes such as methylalumoxane, modified alumoxanes such as modified methylalumoxane, and aluminum alkyls such trimethylaluminum, tri-isobutylaluminum, triethylaluminum, and tri-isopropylaluminum, tri-n-hexylaluminum, tri-n-octylaluminum, tri-n-decylaluminum or tri-n-dodecylaluminum. Co-activators are typically used in combination with Lewis acid activators and ionic activators when the pre-catalyst is not a dihydrocarbyl or dihydride complex. Sometimes co-activators are also used as scavengers to deactivate impurities in feed or reactors.

U.S. Pat. No. 9,409,834 B2 (line 39, column 21 to line 44, column 26) provides a detailed description of the activators and coactivators that may be used with the metallocene compound in the catalyst system of the present disclosure. The relevant portions of this patent are incorporated herein by reference in their entirety.

Additional information of activators and co-activators that may be used with the metallocene compounds in the catalyst system of the present disclosure can be found in U.S. Publication No. 2013/0023633 A1 (paragraph [0178], page 16 to paragraph [0214], page 22). The relevant portions of this reference is incorporated herein by reference in their entirety.

A scavenger is a compound that is typically added to facilitate oligomerization or polymerization by scavenging impurities. Some scavengers may also act as activators and may be referred to as co-activators. A co-activator which is not a scavenger may also be used in conjunction with an activator in order to form an active catalyst with a transition metal compound. In some embodiments, a co-activator can be pre-mixed with the transition metal compound to form an alkylated transition metal compound, also referred to as an alkylated catalyst compound or alkylated metallocene. To the extent scavengers facilitate the metallocene compound in performing the intended catalytic function, scavengers, if used, are sometimes considered as a part of the catalyst system.

U.S. Pat. No. 9,409,834 B2, line 37, column 33 to line 61, column 34 provides detailed description of scavengers useful in the process of the present disclosure for making PAO. The relevant portions in this patent on scavengers, their identities, quantity, and manner of use are incorporated herein in their entirety.

Many Ziegler-Natta catalysts known to one having ordinary skill in the art can be used for making the PAO olefin. Particularly useful ones are those described in U.S. Pat. Nos. 4,827,064 and 4,827,073, the relevant portions thereof are incorporated herein by reference.

The alpha-olefin monomer used in step (I) can be advantageously a linear alpha-olefin described in connection with the PAO block above.

The polymerization or the alpha-olefin monomer in the presence of a metallocene catalyst system or a Ziegler-Natta catalyst system progresses through the insertion of the monomer molecules to the oligomer, resulting in highly regular structure components represented by the structure within the brackets (“[ ]”) of formula:

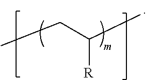

Where each pendant group R has a carbon backbone comprising at least 5 carbon atoms, such a structure component is a bottle-brush component. In a bottle-brush polymer component, the carbon backbone (i.e., the chain formed by the carbon atoms of the m repeating units) is substantially completely extended without bending. The PAO olefin produced in step (II) can be advantageously a bottle-brush polymer.

The oligomerization reaction mixture in step (I) typically comprises unreacted linear alpha-olefin monomer, dimers, and higher oligomers. Upon termination of the oligomerization reaction, the oligomerization reaction mixture is typically separated to remove the unreacted monomer, dimer, and optionally additional light oligomers, to obtain an intended PAO olefin in step (II). The reaction conditions in step (I) and the separation conditions can be chosen such that the PAO olefin has a number average molecular weight in a range from Mn1 to Mn2 grams·mole⁻¹, where Mn1 and Mn2 can be, independently, 1,000, 2,000, 3,000, 4,000, 5,000, 6,000, 7,000, 8,000, 9,000, 10,000, 12,000, 15,000, 16,000, 18,000, 20,000, 22,000, 24,000, 25,000, 26,000, 28,000, 30,000, 35,000, 40,000, 45,000, or 50,000, as long as Mn1<Mn2. Preferably Mn1=2,000 and Mn2=40,000. More preferably Mn1=3,000 and Mn2=30,000. Still more preferably Mn1=5,000 and Mn2=20,000.

The PAO olefin may comprise one or more vinyls, vinylidenes, and/or tri-substituted vinylene olefins at various concentrations. In some embodiments, it is preferred that the PAO olefin comprises at least 50 mol %, or at least 60 mol %, or at least 70 mol %, or at least 80 mol %, or at least 85 mol %, or even at least 90 mol %, of vinylidenes, based on the total moles of all oligomeric olefins therein. In other embodiments, it is preferred that the PAO olefin comprises vinylidenes and tri-substituted vinylenes combined at a concentration of at least 50 mol %, or at least 60 mol %, or at least 70 mol %, or at least 80 mol %, or at least 85 mol %, or at least 90 mol %, or even at least 95 mol %, or even at least 98 mol %, based on the total moles of the oligomeric olefins therein. In the PAO olefin, there may be internal olefins, such as 1,2-di-substituted olefins, which are less reactive, and therefore less favored than the vinylidenes and tri-substituted vinylenes, with respect to typical ATRP agents. Exemplary vinylidene oligomeric olefins, tri-substituted vinylene oligomeric olefins, and 1,2-di-substituted vinylene oligomeric olefins in the PAO olefin are illustrated by the formulae below, wherein the group R's, the same or different at each occurrence, is a linear alkyl group comprising at least 5 carbon atoms, and m is a non-negative integer.

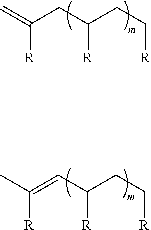

Vinylidene Oligomeric Olefins Tri-Substituted Vinylene Oligomeric Olefins

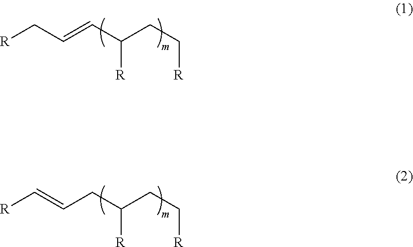

1,2-Di-Substituted Vinylene Oligomeric Olefins (1) and (2)

Vinyls, vinylidenes, and tri-substituted vinylenes comprise highly reactive C═C bond, which can react with selective ATRP agent to convert the PAO olefin molecules into a macro radical polymerization initiator comprising a component corresponding to the PAO olefin in step (III). Desirably, as a result of the reaction between the PAO olefin molecule and the ATRP agent, the C═C bond becomes saturated, leaving no unsaturation in the PAO block.

A preferred ATRP agent is 2-bromoisobutyric acid, which reacts with the C═C bond in vinyl, vinylidene or tri-substituted vinylene PAO olefins. Useful catalysts for the reaction between the PAO olefin and the ATRP agent include Brønsted acids such as trifluoromethane sulfonic acid (TfOH). The reaction can be carried out at a temperature in a range of −20 to 200° C., preferably from 20 to 150° C. The reaction is preferably carried out at ambient pressure. The reaction can be carried out for a time of 0.5 hour to 48 hours and preferably from 2 hours to 24 hours.

Reactions between exemplary vinylidene oligomeric olefins with this ATRP agent to obtain a macro-initiator MI-A can be illustrated in the following Scheme A1.

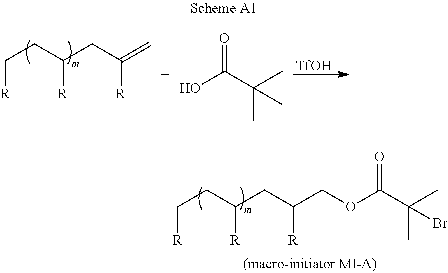

Reactions between exemplary tri-substituted oligomeric olefins with this ATRP agent to obtain a macro-initiator MI-B can be illustrated in the following Scheme B.

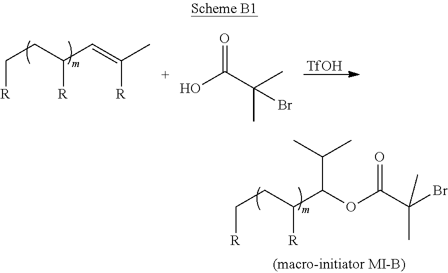

Atom transfer radical polymerization is disclosed, for example, in Preparation of Polyethylene Block Copolymers by a Combination of Postmetallocene Catalysis of Ethylene Polymerization and Atom Transfer Radical Polymerization, Y. Inoue, K. Matyjaszewski, J. Polym. Sci. Part A: Polym. Chem. 2004, Volume 42, 496-504, which is incorporated herein by reference.

The ATRP macro-initiator can then be reacted with one or more alkyl methacrylates to form the poly(alkyl methacrylate) block via atom transfer radical polymerization (ATRP). Useful catalysts include copper halide compounds. A particularly useful catalyst system comprises CuBr and a polyamine (e.g., N,N,N′,N,N pentamethyldiethylenetriamine (PMDETA)). The polymerization can be carried out at a temperature in a range from 0 to 200° C., preferably from 30 to 150° C. The polymerization can be carried out at ambient pressure. The polymerization can be carried out for a period of time of 5 minutes to 96 hours and preferably from 0.5 hour to 60 hours. Polymerization conditions are disclosed, for example, in Preparation of Polyethylene Block Copolymers by a Combination of Postmetallocene Catalysis of Ethylene Polymerization and Atom Transfer Radical Polymerization, Y. Inoue, K. Matyjaszewski, J. Polym. Sci. Part A: Polym. Chem. 2004, Volume 42, 496-504, which is incorporated herein by reference.

By way of example, the syntheses of a di-block copolymer from macro-initiator MI-A and MI-B above by polymerization with an alkyl methacrylate (CH₂═C(CH₃)—C(O)—O—R′) monomer in the presence of CuBr and a polyamine can be illustrated below in Scheme A2 and Scheme B2, respectively:

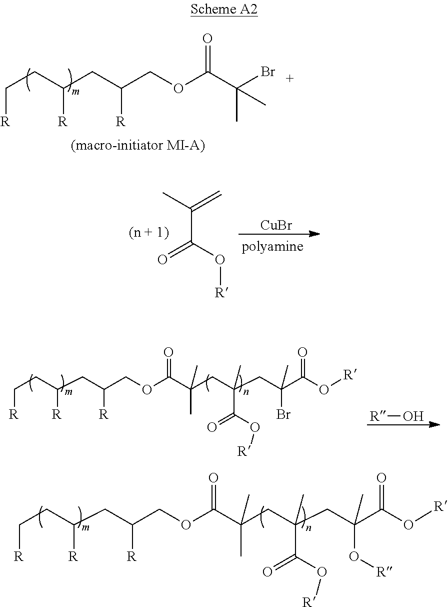

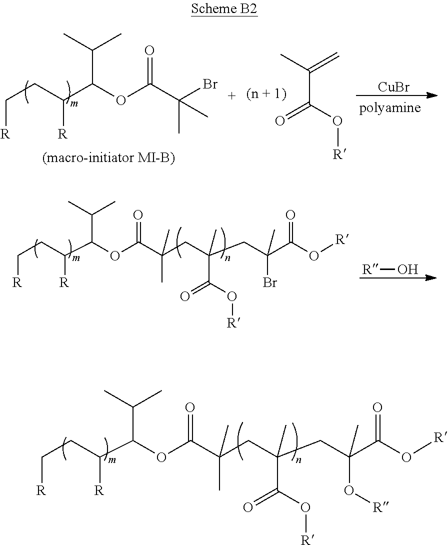

In the block copolymers shown in Schemes B1 and B2 above, between the PAO block obtained by oligomerization of linear alpha-olefin(s) and the PAMA block obtained by radical polymerization of the alkyl methacrylate monomer(s), there is a linking group represented by the moiety between the brackets (“[ ]”) of the following formula, which resulted from the ATRP agent reacting with the PAO olefin:

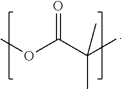

This linking group advantageously has a structure very similar to the structural units resulting from the alkyl methacrylate monomer in the PAMA block.

ATRP is a controlled radical polymerization process in which a live free radical propagates until the completion of the polymerization in the presence of the catalyst system. At the end of the polymerization of the alkyl methacrylate monomer, one can quench the reaction mixture by adding a polar material such as water or an alcohol (R″—OH as indicated in Schemes A2 and B2, where R″ can be hydrogen or any alkyl group) which will terminate the polymerization to result in a di-block copolymer of this disclosure. As a result of the reaction between the quenching agent and the macro free radical, the PAMA block chain end is capped by a group derived from the quenching agent (—OR″ as illustrated in Schemes A2 and B2).

The alkyl methacrylate monomer used in the process of this disclosure can be advantageously a monomer described above in connection with the PAMA block.

The ATRP agent and the ATRP polymerization reaction conditions can be conveniently selected such that a PAMA block described above is produced. Particularly, a PAMA block produced by ATRP polymerization illustrated above can advantageously have a number average molecular weight in a range from Mn3 to Mn4 grams mole⁻¹, where Mn3 and Mn4 can be, independently, 1,000, 2,000, 3,000, 4,000, 5,000, 6,000, 7,000, 8,000, 9,000, 10,000, 12,000, 15,000, 16,000, 18,000, 20,000, 22,000, 24,000, 25,000, 26,000, 28,000, or 30,000, as long as Mn3<Mn4. As mentioned above, the number average molecular weight of the PAMA block can be calculated by subtracting the number average molecular weight of the PAMA block and the molecular weight of the linking group from the number average molecular weight of the block copolymer.

VI. Viscosity Improver Comprising the Block Copolymer of this Disclosure

The block copolymer of this disclosure as described above can be particularly useful as a viscosity improver of a lubricant oil composition, including but not limited to internal combustion engine oil, transmission fluids, industrial oils, hydraulic fluids, and the like. Thus, a lubricant oil composition viscosity improver comprising a block copolymer of this disclosure constitutes one aspect of this disclosure.

An viscosity improver can comprise one or more of the block copolymer of this disclosure at any concentration, e.g., a concentration of at least 50 wt %, at least 60 wt %, at least 70 wt %, at least 80 wt %, at least 90 wt %, at least 95 wt %, or even at least 98 wt %, or even 100 wt %, based on the total weight of the viscosity improver.

A viscosity improver can comprise, in addition to the block copolymer of this disclosure, other components such as a solvent. The solvent can be, e.g., a low-viscosity Group I, II, III, or IV base stock.

Desirably, the viscosity improver has the following attribute: when blended with a PAO base stock having a KV100 of 4.0 cSt to form a mixture at a concentration of the block copolymer at 0.5 wt % based on the total weight of the mixture formed, the mixture exhibits a shear-thinning onset shear rate at 100° C. of no higher than 1×10⁵ s⁻¹, or no higher than 8×10⁴ s⁻¹, or no higher than 6×10⁴ s⁻¹, or no higher than 5×10⁴ s⁻¹, or no higher than 4×10⁴ s⁻¹, or even no higher than 2×10⁴ s⁻¹. The block copolymer of this disclosure can exhibit such exceedingly low shear-thinning onset shear rate, making it particularly advantageous as a viscosity improver in lubricant oil compositions comprising hydrocarbon base stocks, such as Group IV base stocks.

Desirably, the viscosity improver further has the following attribute: when blended with a PAO base stock having a KV100 of 4.0 cSt to form a mixture at a concentration of the block copolymer at 0.5 wt % based on the total weight of the mixture formed, the mixture produced exhibits shear thinning at 100° C. at 1×10⁶ s⁻¹, or 2×10⁶ s⁻¹, or 3×10⁶ s⁻¹, or 4×10⁶ s⁻¹, or 5×10⁶ s⁻¹. The block copolymer of this disclosure can continue to exhibit shear-thinning at such high shear rate, making it particularly advantageous as a viscosity improver in lubricant oil compositions comprising hydrocarbon base stocks, such as Group IV base stocks.

### VII. Lubricant Oil Composition Comprising the Block Copolymer

### VII.1 General

When a block copolymer of this disclosure is used as a viscosity improver in a lubricant oil composition, it may be desirably used at a concentration in a range from y1 to y2 wt %, based on the total weight of the lubricant oil composition, where y1 and y2 can be, independently, 0.1, 0.2, 0.3, 0.4, 0.5, 0.6, 0.7, 0.8, 0.9, 1.0, 1.5, 2.0, 2.5, 3.0, 3.5, 4.0, 4.5, or 5.0, as long as y1<y2. The inclusion of the block copolymer of this disclosure, even at such small concentration, can significantly improve the viscosity index of the lubricant oil composition. A lubricant oil composition comprising a block copolymer of this disclosure also constitutes an aspect of this disclosure.

The lubricant oil composition comprising the block copolymer as a viscosity improver can comprise one or more base stocks, particularly hydrocarbon base stocks, and one or more additives other than the block copolymer viscosity improver.

### VII.2 Base Stocks

A wide range of lubricating oil base stocks known in the art can be used in the lubricant oil compositions of this disclosure, as primary base stock or co-base stock. Such base stocks can be either derived from natural resources or synthetic, including un-refined, refined, or re-refined oils. Un-refined oil base stocks include shale oil obtained directly from retorting operations, petroleum oil obtained directly from primary distillation, and ester oil obtained directly from a natural source (such as plant matters and animal tissues) or directly from a chemical esterification process. Refined oil base stocks are those un-refined base stocks further subjected to one or more purification steps such as solvent extraction, secondary distillation, acid extraction, base extraction, filtration, and the like to improve the at least one lubricating oil property. Re-refined oil base stocks are obtained by processes analogous to refined oils but using an oil that has been previously used as a feed stock.

API Groups I, II, III, IV and V are broad categories of base stocks developed and defined by the American Petroleum Institute (API Publication 1509; www.API.org) to create guidelines for lubricant base stocks. Group I base stocks generally have a viscosity index of from about 80 to 120 and contain greater than about 0.03% sulfur and less than about 90% saturates. Group II base stocks generally have a viscosity index of from about 80 to 120, and contain less than or equal to about 0.03% sulfur and greater than or equal to about 90% saturates. Group III stock generally has a viscosity index greater than about 120 and contains less than or equal to about 0.03% sulfur and greater than about 90% saturates. Group IV includes polyalphaolefins (PAO). Group V base stocks include base stocks not included in Groups I-IV. The table below summarizes properties of each of these five groups.

Base Stock Properties

| | Saturates | Sulfur | Viscosity Index |
|---|---|---|---|
| Group I | <90 and/or | >0.03% and | ≥80 and <120 |
| Group II | ≥90 and | ≤0.03% and | ≥80 and <120 |
| Group III | ≥90 and | ≤0.03% and | ≥120 |

| | |
|---|---|
| Group IV | Includes polyalphaolefins (PAO) products |
| Group V | All other base stocks not |
| | included in Groups I, II, III or IV |

Natural oils include animal oils (e.g. lard), vegetable oils (e.g., castor oil), and mineral oils. Animal and vegetable oils possessing favorable thermal oxidative stability can be used. Of the natural oils, mineral oils are preferred. Mineral oils vary widely as to their crude source, e.g., as to whether they are paraffinic, naphthenic, or mixed paraffinic-naphthenic. Oils derived from coal or shale are also useful in this disclosure. Natural oils vary also as to the method used for their production and purification, e.g., their distillation range and whether they are straight run or cracked, hydrorefined, or solvent extracted.

Group II and/or Group III base stocks are generally hydroprocessed or hydrocracked base stocks derived from crude oil refining processes.

Synthetic base stocks include polymerized and interpolymerized olefins (e.g., polybutylenes, polypropylenes, propylene isobutylene copolymers, ethylene-olefin copolymers, and ethylene-alphaolefin copolymers).

Synthetic polyalphaolefins (“PAO”) base stocks are placed into Group IV. Advantageous Group IV base stocks are those made from one or more of C6, C8, C10, C12, and C14 linear alpha-olefins (“LAO”s). These base stocks can be commercially available at a wide range of viscosity, such as a KV100 in a range from 1.0 to 1,000 cSt. The PAO base stocks can be made by polymerization of the LAO(s) in the presence of Lewis-acid type catalyst, or in the presence of a metallocene compound-based catalyst system. High quality Group IV PAO commercial base stocks including the SpectraSyn™ and SpectraSyn Elite™ series available from ExxonMobil Chemical Company having an address at 4500 Bayway Drive, Baytown, Tex. 77520, United States.

All other synthetic base stocks, including but not limited to alkyl aromatics and synthetic esters are in Group V.

Esters in a minor amount may be useful in the lubricant oil compositions of this disclosure. Additive solvency and seal compatibility characteristics may be imparted by the use of esters such as the esters of dibasic acids with monoalkanols and the polyol esters of monocarboxylic acids. Esters of the former type include, e.g., the esters of dicarboxylic acids such as phthalic acid, succinic acid, sebacic acid, fumaric acid, adipic acid, linoleic acid dimer, malonic acid, alkyl malonic acid, alkenyl malonic acid, etc., with a variety of alcohols such as butyl alcohol, hexyl alcohol, dodecyl alcohol, 2-ethylhexyl alcohol, and the like. Specific examples of these types of esters include dibutyl adipate, di(2-ethylhexyl) sebacate, di-n-hexyl fumarate, dioctyl sebacate, diisooctyl azelate, diisodecyl azelate, dioctyl phthalate, didecyl phthalate, dieicosyl sebacate, etc. Useful ester-type Group V base stock include the Esterex™ series commercially available from ExxonMobil Chemical Company.

One or more of the following may be used as a base stock in the lubricating oil of this disclosure as well: (1) one or more Gas-to-Liquids (GTL) materials; and (2) hydrodewaxed, hydroisomerized, solvent dewaxed, or catalytically dewaxed base stocks derived from synthetic wax, natural wax, waxy feeds, slack waxes, gas oils, waxy fuels, hydrocracker bottoms, waxy raffinate, hydrocrackate, thermal crackates, foots oil, and waxy materials derived from coal liquefaction or shale oil. Such waxy feeds can be derived from mineral oils or non-mineral oil processing or can be synthetic (e.g., Fischer-Tropsch feed stocks). Such base stocks preferably comprise linear or branched hydrocarbyl compounds of C20 or higher, more preferably C30 or higher.

The lubricant oil compositions of this disclosure can comprise one or more Group I, II, III, IV, or V base stocks in addition to the CCSV-reducing base stock. Preferably, Group I base stocks, if any, is present at a relatively low concentration if a high quality lubricating oil is desired. Group I base stocks may be introduced as a diluent of an additive package at a small quantity. Groups II and III base stocks can be included in the lubricant oil compositions of this disclosure, but preferably only those with high quality, e.g., those having a VI from 100 to 120. Group IV and V base stocks, preferably those of high quality, are desirably included into the lubricant oil compositions of this disclosure.

### VIL3 Lubricating Oil Additives

The formulated lubricating oil useful in this disclosure may additionally contain one or more of the commonly used lubricating oil performance additives including but not limited to dispersants, detergents, viscosity modifiers other than the block copolymer of this disclosure, antiwear additives, corrosion inhibitors, rust inhibitors, metal deactivators, extreme pressure additives, anti-seizure agents, wax modifiers, fluid-loss additives, seal compatibility agents, lubricity agents, anti-staining agents, chromophoric agents, defoamants, demulsifiers, densifiers, wetting agents, gelling agents, tackiness agents, colorants, and others. For a review of many commonly used additives and the quantities used, see: (i) Klamann in Lubricants and Related Products, Verlag Chemie, Deerfield Beach, Fla.; ISBN 0-89573-177-0; (ii) “Lubricant Additives,” M. W. Ranney, published by Noyes Data Corporation of Parkridge, N J (1973); (iii) “Synthetics, Mineral Oils, and Bio-Based Lubricants,” Edited by L. R. Rudnick, CRC Taylor and Francis, 2006, ISBN 1-57444-723-8; (iv) “Lubrication Fundamentals”, J. G. Wills, Marcel Dekker Inc., (New York, 1980); (v) Synthetic Lubricants and High-Performance Functional Fluids, 2nd Ed., Rudnick and Shubkin, Marcel Dekker Inc., (New York, 1999); and (vi) “Polyalphaolefins,” L. R. Rudnick, Chemical Industries (Boca Raton, Fla., United States) (2006), 111 (Synthetics, Mineral Oils, and Bio-Based Lubricants), 3-36. Reference is also made to: (a) U.S. Pat. No. 7,704,930 B2; (b) U.S. Pat. No. 9,458,403 B2, Column 18, line 46 to Column 39, line 68; (c) U.S. Pat. No. 9,422,497 B2, Column 34, line 4 to Column 40, line 55; and (d) U.S. Pat. No. 8,048,833 B2, Column 17, line 48 to Column 27, line 12, the disclosures of which are incorporated herein in its entirety. These additives are commonly delivered with varying amounts of diluent oil that may range from 5 wt % to 50 wt % based on the total weight of the additive package before incorporation into the formulated oil. The additives useful in this disclosure do not have to be soluble in the lubricant oil compositions. Insoluble additives in oil can be dispersed in the lubricant oil compositions of this disclosure.

When lubricant oil compositions contain one or more of the additives discussed above, the additive(s) are blended into the oil composition in an amount sufficient for it to perform its intended function.

It is noted that many of the additives are shipped from the additive manufacturer as a concentrate, containing one or more additives together, with a certain amount of base oil diluents. Accordingly, the weight amounts in the table below, as well as other amounts mentioned herein, are directed to the amount of active ingredient (that is the non-diluent portion of the ingredient). The weight percent (wt %) indicated below is based on the total weight of the lubricating oil formulation.

This disclosure is further illustrated by the following non-limiting examples.

### EXAMPLES

In the following examples herein, “Mn” denotes number-average molecular weight, “Mw” denotes weight-average molecular weight,” “PDI” denotes polydispersity, “TfOH” denotes trifluoromethane sulfonic acid, and “IPAO” denotes isopropyl alcohol.

### Example A: Synthesis of PAO Oligomer Olefin Mixture

Starting from a mixed feed comprising 1-octene, 1-decene, and 1-dodecene, a PAO oligomer olefin mixture (“uPAO”) having a number-average molecular weight of 6,500 grams·mole⁻¹ was synthesized in a solution reactor, with isohexane as the solvent, by coordinative insertion polymerization in the presence of a catalyst system comprising a C2 symmetric bridged metallocene compound (rac-dimethylsilylene bis(tetrahydroindenyl) zirconium dimethyl) activated with dimethylanilinium tetrakis(pentafluorophenyl) borate. Based on proton NMR, the resulting PAO oligomer olefin mixture comprises about 35% vinylidenes, 45% 1,2-disubstituted vinylenes, and 20% tri-substituted vinylenes, by weight and based on the total weight of the three types of oligomeric olefins.

### Example B: Conversion of Vinylidenes and Vinylenes to Alkyl Halide ATRP Initiators

The uPAO needs to be converted first to ATRP (atom transfer radical polymerization) macro-initiator which can then initiate the subsequent ATRP polymerization of alkyl methacrylate. Under nitrogen protection, the uPAO was mixed and dissolved in chlorobenzene solvent and the solution was heated to 100° C. for a complete dissolution after which 2-bromoisobutyric acid was then added. TfOH catalyst was added to the reaction flask with the reaction mixture stirring at 100° C. for 18 hours. After cooling down, the reaction mixture was precipitated into an excess isopropanol and filtered using a silica gel column to remove unreacted bromoisobutyric acid. The filtered product was dried in a vacuum oven at 80° C. overnight to obtain the PAO-based ATRP macro imitator. Proton NMR confirmed the chain end conversion to alkyl bromide. Reactions are illustrated in Schemes A1 and B1 above.

### Example C: Synthesis of PAO-b-PEHMA Di-Block Copolymer

The PAO-based macro initiator prepared in Example B above and CuBr were first dissolved in anhydrous toluene. Inhibitor in 2-ethylhexyl methacrylate (“EHMA”) monomer was removed by passing EHMA through a silica gel purification column. After purification, EHMA was added to the reaction mixture which was purged with N₂ and heated to 90° C. Afterwards, N,N,N′,N,N-pentamethyldiethylenetriamine (“PMDETA”) catalyst was added and the reaction was allowed to run for 4 hours. Once the reaction was complete, the reaction mixture was cooled to room temperature and filtered through a thin pad of silica gel. The silica gel was washed with several batches of fresh toluene and the resulting toluene solutions were precipitated in IPAO and dried. Proton NMR was applied to confirm the polymerization reaction. Based on GPC-DRI (gel permeation chromatography—differential refractive index detector) graphs, thus synthesized PAO-b-PEHMA di-block copolymer was found to have a Mn of 4,400, a Mw of 16,200 and a PDI of 3.7. Additionally, the formation and presence of the PAO-b-PEHMA diblock copolymer were confirmed by ion mobility mass spectrometry, which also showed the formation of EHMA homopolymer at a small quantity. Reactions are illustrated in Schemes A2 and B2 above where the R′ group is 2-ethyl-1-hexyl.

### Example D: Synthesis of PAO-b-PDDMA Di-Block Copolymer

The uPAO-based macro initiator prepared in Example B above and CuBr were first dissolved in anhydrous toluene. Inhibitor in lauryl methacrylate (i.e., dodecyl methacrylate (DDMA)) monomer was removed by passing DDMA through a silica gel purification column. After purification, DDMA was added to the reaction mixture which was purged with N₂ and heated to 90° C. Afterwards, PMDETA catalyst was added and the reaction was allowed to run for 4 hours. Once the reaction was complete, the reaction mixture was cooled to room temperature and filtered through a thin pad of silica gel. The silica gel was washed with several batches of fresh toluene and the resulting toluene solutions were precipitated in IPAO and dried. Proton NMR was applied to confirm the polymerization reaction. GPC indicated the PAO-b-PDDMA di-block copolymer has a Mn of 5,800, a Mw of 25,700, and a PDI of 4.4. The formation and presence of the PAO-b-PDDMA di-block were also confirmed by ion mobility mass spectrometry.

### Example E: Rheological Performance of PAO-b-PAMA Viscosity Modifiers in PAO Base Stock

Lubricant solution blending experiments were carried out using the following materials:

PAO-4: a commercial polyalphaolefin lubricant base stock available as SpectraSyn™ 4 from ExxonMobil Chemical Company, 4500 Bayway Drive, Baytown, Tex. 77520, U.S.A, having a kinematic viscosity at 100° C. of 4 cSt (made by cationic oligomerization); and Paratone 8900E (“P8900E”): a commercial olefin copolymer viscosity modifier available from ExxonMobil Chemical Company, having a number-average molecular weight of about 85,000, as a comparative viscosity modifier.

P8900E, PAO-b-PEHMA di-block copolymer made in Example C and PAO-b-PDDMA di-block copolymers made in Example D above were separately blended with PAO-4 at 0.5 wt % (P8900E) or 1 wt % (PAO-b-PEHMA and PAO-b-PDDMA) with the addition of antioxidants of Irganox 1076 at 0.015 wt % and Irgafos 168 at 0.005 wt % to make three oil compositions comprising three different viscosity modifiers, where the percentages are based on the total weight of the oil compositions. Antioxidants are necessary to prevent polymer degradation during their rheological evaluations. Due to the low molecular weight values of these two di-block copolymers synthesized, 1% concentration was used, instead of the 0.5 wt %, so to have sufficient thickening for subsequent rheological measurements.

Without intending to be bound by a particular theory, it is believed that the PAO-b-PEHMA and the PAO-b-PDDMA macro molecules form micelle structures having a core formed from the PAMA blocks of multiple di-block copolymer molecules, and a corona formed from the PAO blocks connected to the PAMA blocks that coalesce to form the core. This is because PAMA has low solubility in PAO-4 base stock while the PAO block has similar structure to the PAO-4 base stock. The micelles provide thickening effect to the oil compositions resulting in a viscosity of the mixture at low shear rate and low temperature higher than that of the PAO-4 base stock.

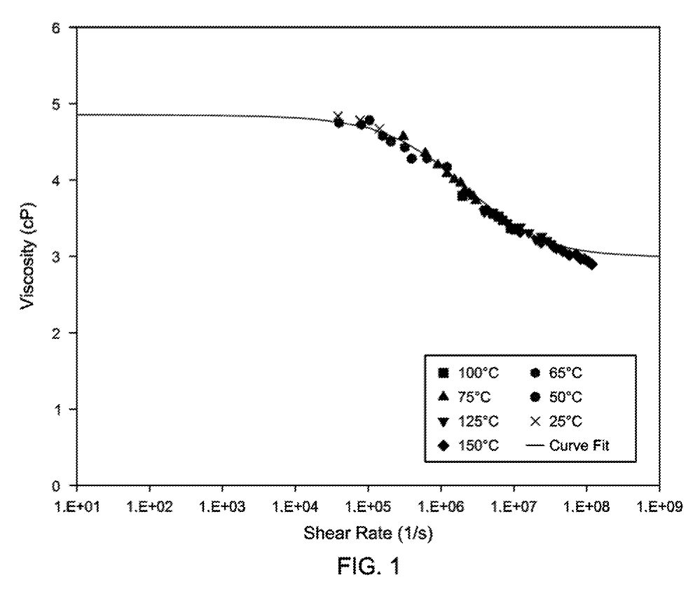

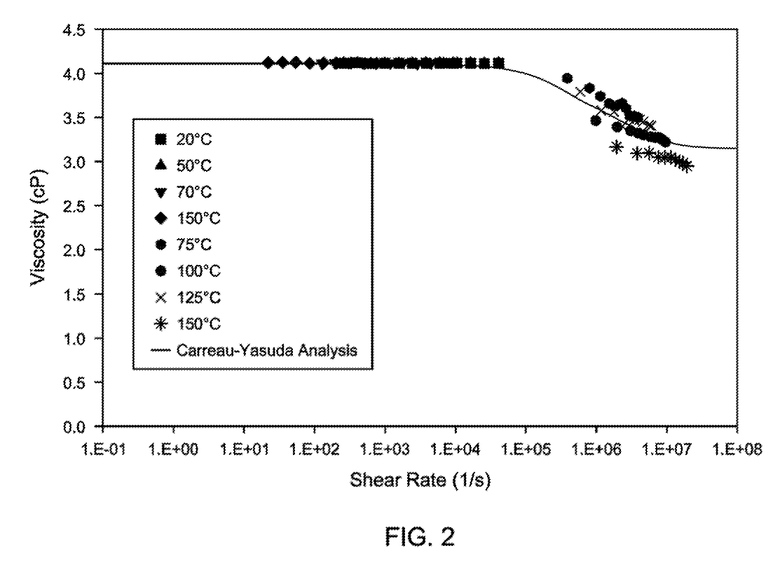

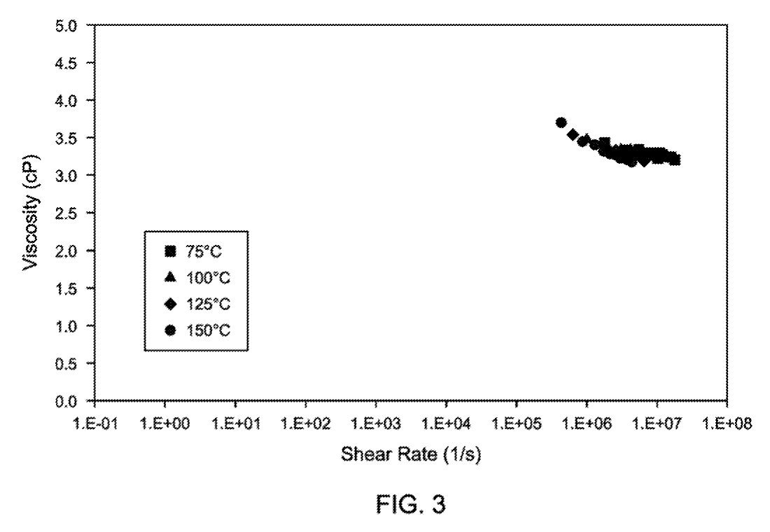

Using an ultra-high shear viscometer (shear rate range from 10⁶ to 10⁷ s⁻¹) (USV (Ultra Shear Viscometer) from PCS Instruments having an address at 78 Stanley Gardens, London, W3 7SZ, United Kingdom) and a m-VROC micro-capillary viscometer (shear rate range from 10³ to 10⁶ s⁻¹) (from RheoSence having an address at 2420 Camino Ramon, Suite 240 San Ramon, Calif. 9458, United States) operating at various temperatures, viscosity values as functions of shear rate and temperature of the oil scan were obtained. Based on the principle of time-temperature correspondence, time-temperature superposition (TTS) was then applied to consolidate all measured data into one single viscosity master curve (as shown in FIGS. 1 and 2 for Paratone 8900G and PAO-b-PDDMA, respectively, at a reference temperature of 100° C. using shift factors. Only ultra-high-shear viscosity data for PAO-b-PEHMA are shown in FIG. 3).

Thus obtained viscosity curve can be fitted to a five-parameter non-Newtonian Carreau-Yasuda model as shown below.

$$\frac{η - {η}_{∞}}{{η}_{0} - {η}_{∞}} = {[ 1 + {( λ \dot{γ} )}^{a} ]}^{( n - 1 ) / a}$$

This is a pseudoplastic flow model with asymptotic viscosities at zero, η₀, and at infinite, η_{∞}, shear rates and with no yield stress. The parameter 1/λ is the critical shear rate at which viscosity begins to decrease, or onset of the shear thinning, and the power-law slope is (n−1) which is the shear thinning slope. The parameter “a” represents the width of the transition region between zero shear viscosity and the power-law region, or the transition from Newtonian to shear thinning. The infinite viscosity in this case is set to the viscosity of base stock PAO-4.

As indicated, earlier shear thinning onset and gentle shear thinning slope are shown for both oil compositions comprising the di-block copolymers. Without intending to be bound by a particular theory, it is believed that the micelles start to break up at the shear-thinning onset shear rate. At the high shear rates, e.g., higher than 10⁶ s⁻¹, the oil compositions containing the di-block copolymers have lower viscosity than at lower shear rate as the result of their shear thinning. For passenger vehicle and commercial vehicle lubricant applications, there is a viscous loss of the engine oil affecting the fuel economy at the steady-state running of an engine. It is generally agreed that this viscous contribution be determined by viscosity values at shear rates from 4×10⁵ to 10⁶ s⁻¹ measured at temperatures ranging from 100 to 150° C., depending on the vehicle service. There is a specified HTHS (high-temperature high-shear-rate) minimum viscosity for each viscosity grade, measured at 10⁶ s⁻¹ shear rate and 150° C. The shear rate and temperature defined for HTHS viscosity measurement are reflecting the flow environment in an operating crankshaft bearing at steady state. Viscosity modifiers are added in lubricants to thicken the lubricant base stock so that a lower viscosity and higher viscosity index base stock can be used for an overall improvement in viscosity index of the resulting lubricants. In lubricant oil compositions containing viscosity modifiers, shear thinning is then desirable for the lubricant oil composition to have lower high-shear-rate viscosity and good fuel economy. It is preferred for a polymer viscosity modifier to deliver an earlier shear thinning onset at shear rates below 10⁵ s⁻¹ and a gentle shear thinning slope so the viscosity loss with increasing shear rates would not be drastic and below the HTHS minimum viscosity that can lead to wear. The oil compositions containing PAO-b-PDDMA and PAO-b-PEHMA can thus be expected to have excellent viscometric performance and fuel economy. The lower zero shear viscosity value of PAO-b-PDDMA containing oil composition, or the lower thickening efficiency of PAO-b-PDDMA, is the result of the low molecular weight of the PAO block as used in the examples. It is expected that a PAO block with a Mn of 25,000, instead of 6,500, would deliver thickening efficiency equivalent to those obtained from commercial viscosity modifiers.

### Example F (Comparative Example)

F1: Synthesis of Vinyl Terminated Atactic Polypropylene (aPP)

Polymerization of propylene was performed in a 2-liter stainless steel autoclave conditioned by steam heating and maintained under a nitrogen atmosphere. Triisobutyl aluminum (0.5 ml, 1.0M) was added via syringe followed by propylene (800 ml). The stirrer was maintained at 900 rpm and the autoclave contents heated to 45° C. A catalyst solution in 5 mil of toluene (containing 3 mg of rac-dimethylsilylbis(2-methyl,3-propyl indenyl)hafnium dimethyl catalyst and 6 mg of dimethyl anilinium tetrakisperfluoronapthyl borate activator) was added by nitrogen pressurized catalyst tube. The polymerization proceeded for 17 minutes at which time the reaction was cooled and excess pressure slowly vented away. The contents were dissolved in hexane (200 ml) and transferred into a glass vessel. After removing volatiles, the product was dried in vacuum at 70° C. for 12 hours. A NMR spectrum of this aPP showed >90 mole % vinyl chain ends and a GPC curve of this aPP indicated 54,000 Mn (number average molecular weight) with a 3.62 PDI.

F2: Synthesis of ATRP Macro-Initiator from Vinyl Terminated aPP

A 100 mL round-bottom flask was charged with 2.3742 g vinyl-terminated atactic polypropylene prepared in step F1 above, VTaPP, and 24.5 mL chlorobenzene. The mixture was heated to 100° C. to dissolve the VT aPP, after which 1.4772 g 2-bromoisobutyric acid was added to the flask. Then 0.5 mL chlorobenzene solution containing 0.002 g TfOH was injected to the reaction flask. The reaction mixture was stirred at 100° C. for 18 hours. After cooling down, the reaction mixture was dropped slowly into a stirring 500 mL methanol to precipitate out the polymer product. The methanol was decanted and fresh methanol was added. After stirring for 15 minutes, the methanol was decanted. The process was repeated two more times. The white polymer was placed in a vacuum oven at 80° C. overnight. A proton NMR of this product indicated it contained free 2-bromoisobutyric acid. The polymer was then re-dissolved in toluene and added slowly drop-wise to a 500 mL stirring methanol. The methanol was decanted and the same rinsing process was repeated for three times. The white polymer was placed in a vacuum oven at 60° C. overnight. The dried polymer turned slightly grey and transparent. The recovered final product was 2.2 g (93% yield). Proton NMR of this purified product showed the CH proton next to ester (indicating the formation of macro-initiator) and the isobutyl protons was at 1:6 ratio, implying no free 2-bromoisobutyric acid was left. An elemental analysis of this product showed no Br. The theoretical Br content is about 0.14%, which is below the detecting limit of conventional Br elemental analysis. The Br elemental analysis further confirmed there was no free 2-bromoisobutyric acid left, making sure the next ATRP polymerization is initiated by the aPP macro-initiator to form di-block copolymers, but not from the 2-bromoisobutyric acid to form a blend of two homopolymers.

F3: Synthesis of aPP-b-PBMA Di-Block Copolymer

A 50 mL round-bottom flask was charged with 0.45 g aPP ATRP macro-initiator prepared in step F2 above, 0.143 g CuBr and 10 mL toluene. The mixture was stirred to dissolve the aPP macro-initiator. Then 8 mL butyl methacrylate (BMA) was injected into the flask. After mixing, 0.21 mL pentamethyl-diethylene-triamine (PMDETA) was injected to initiate the reaction. The reaction mixture was heated at 100° C. for designated time to control the molecular weight of the PBMA block. After cooling down, the reaction mixture was dropped slowly into a stirring 500 mL methanol to precipitate out the polymer product. The methanol was decanted and fresh methanol was added. After stirring for 15 minutes, the methanol was decanted. The process was repeated two more times. The polymer was placed in a vacuum oven at 60° C. overnight. The product was re-dissolved in a small amount of toluene and precipitated to 500 mL methanol. The same rinsing process was repeated for three times. The purified polymer was dried in a vacuum oven at 40° C. over two days. The product was characterized by NMR and GPC, which showed mono-modal traces, confirming the di-block nature. The final number average molecular weight of the PBMA block is 1,300.

F4: Synthesis of aPP-b-PODMA Di-Block Copolymer

A 50 mL round-bottom flask was charged with 0.53 g aPP ATRP macro-initiator prepared in step F2 above, 0.143 g CuBr and 15 mL toluene. The mixture was stirred to dissolve the aPP macro-initiator. Then 6.77 g 2-octyldecyl methacrylate (ODMA) was added into the flask. After mixing, 0.21 mL pentamethyl-diethylene-triamine (PMDETA) was injected to initiate the reaction. The reaction mixture was heated at 100° C. for designated time to control the molecular weight of the PODMA block. After cooling down, the reaction mixture was dropped slowly into a stirring 500 mL methanol to precipitate out the polymer product. The polymer was filtered and fresh methanol was added. After stirring for 15 minutes, the polymer was filtered. The process was repeated two more times. The polymer was placed in a vacuum oven at 60° C. overnight. The product was re-dissolved in a small amount of toluene and precipitated to 500 mL isopropanol. The same rinsing process was repeated for three times. The purified polymer was dried in a vacuum oven at 40° C. over 2 days. The product was characterized by NMR and GPC, which showed mono-modal traces, confirming the di-block nature with a final number average molecular weight for the PODMA block being 302,000.

### F5: Comparative Viscosity Curves of PAO-4 Lubricant Solutions

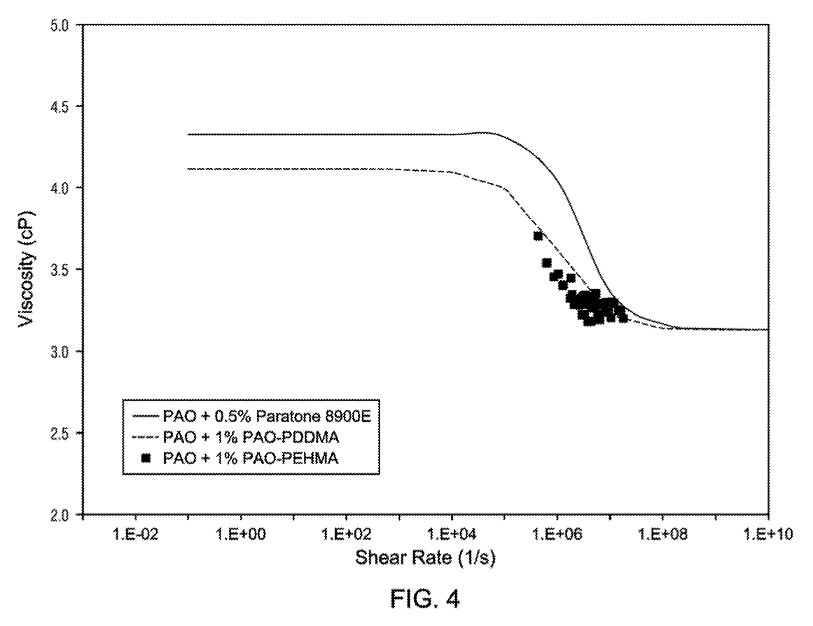

One gram of aPP (linear commercial atactic polypropylene of 280K Mn), SV140 (commercial ShellVis viscosity modifier of 120K Mn, a commercial di-block poly((alternated ethylene-propylene)-b-styrene, or P(altEP-b-S)), aPP-b-PBMA (54K-b-1K) prepared in step F3 above, and aPP-b-PODMA (54K-b-302K) prepared in step F4 above each plus 0.015 g Irganox 1076 antioxidant, 0.005 g Irgafos 168 antioxidant were dissolved in 98.98 g of PAO-4 base stock to make up a total of 100 g lubricant solution. Viscosity curves of these lubricant solutions were obtained in the same manner as discussed above in Example E using a combination of time-temperature superposition and multiple viscometers (ultra-high shear, and micro-capillary) followed by fitting to Carreau-Yasuda equation. Thus acquired viscosity curves are plotted in FIG. 4. The linear aPP has the highest thickening, or zero shear viscosity, for its high molecular weight. Although high molecular weight of a linear viscosity modifier can provide thickening efficiency, through its large coils, these linear chains can be easily degraded (by scission under ultra-high shear stress). Our previous study found that chains with number average molecular weight greater than 80,000 can be broken down by shear stress generated at shear rate greater than 10⁸ s⁻¹. Additionally, it can be seen that linear chains shear thin at much high shear rate and have a very steep shear thinning slope, both of which are not desirable. Most notably is that the viscosity at 10⁶ s⁻¹ shear rate is the highest which would not provide fuel economy.

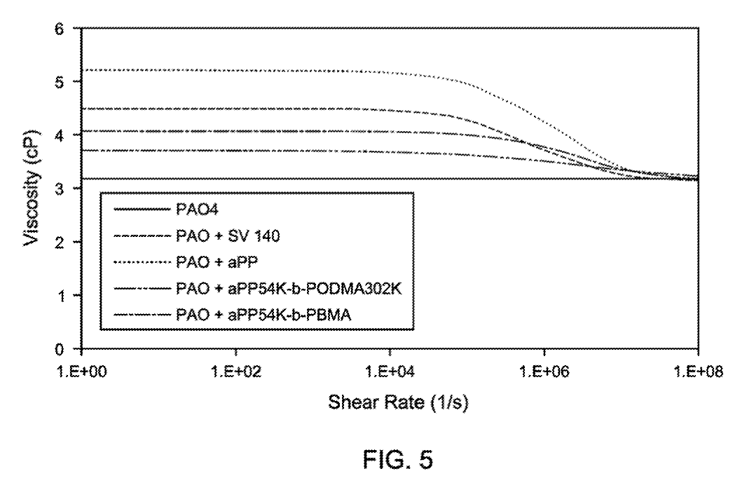

All three di-block copolymers shown in FIG. 5 exhibited shear-thinning early at a relatively low shear rate and have gentle shear thinning slope. The aPP-b-PODMA has tiny micelles and strong micellization strength in PAO-4 due to the high immiscibility of high molecular weight PODMA block in PAO-4. In turn, these lead to poor thickening efficiency (small micelles) and delayed shear thinning onset (high micelle strength requires high shear stress at high shear rate to break up micelles). The aPP-b-PBMA has better thickening efficiency and earlier shear thinning onset than the aPP-b-PODMA, along with gentle shear thinning slope. The aPP-b-PBMA has less thickening efficiency than SV140 due to its lower molecular weight (Mn of about 55,000 for aPP-b-PBMA versus about 120,000 for SV140). However, SV140 is subject to degradation resulting from scission because the molecular weight is extraordinarily high.

The aPP-b-PBMA and SV140 are micelle forming di-block copolymers with coiled micelle corona as opposed to the inventive examples of PAO-b-PDDMA (Example D) and PAO-b-PEHMA (Example C) which are micelle forming di-block copolymer with “extended” rod-like PAO corona. They all have relatively early shear thinning onset and gentle shear thinning slope. But the PAO-b-PDDMA at 19,000 overall Mn and the PAO-b-PEHMA at about 10,000 overall Mn already can deliver better thickening efficiency than that can be obtained from the aPP-b-PBMA at an overall Mn of about 55,000, demonstrating the effect of extended rod-like PAO corona. It is expected that a PAO-b-PEHMA with an overall Mn of about 20,000 to 30,000 (merely ⅙ to ¼ of the Mn of SV140) can provide equivalent or better thickening with much lower risk of scission degradation than that of SV140 because the Mn is far below the scission Mn limit of 80,000. Additionally, with a PAMA core in these micelles which is known to expand with temperature for excellent viscosity index, or low viscosity changes with temperature, they are expected to have superior viscosity index than that of SV140 which has a PS (polystyrene) core that is known to contract with temperature and raise the viscosity changes with temperature.

All patents and patent applications, test procedures (such as ASTM methods, UL methods, and the like), and other documents cited herein are fully incorporated by reference to the extent such disclosure is not inconsistent with this disclosure and for all jurisdictions in which such incorporation is permitted.

1. A block copolymer comprising:
an alpha-olefin polymer block (“PAO block”) derived from one or more alpha-olefin monomer comprising more than six (6) carbon atoms per molecule, the PAO block comprising a component represented by the structure within the brackets (“[ ]”) of the following formula (F-I): 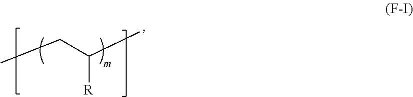
wherein each R, the same or different at each occurrence in the respective structural unit, is independently an alkyl group having a carbon backbone comprising at least five (5) carbon atoms, and m is an integer equal to or greater than five (5); and
an alkyl methacrylate polymer block (“PAMA block”) derived from one or more alkyl methacrylate monomer, the PAMA block comprising a component represented by the structure within the brackets (“[ ]”) of the following formula (F-II): 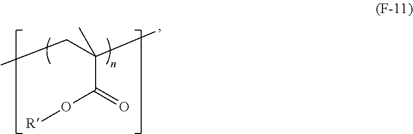
wherein each R′, the same or different at each occurrence in the respective structural unit, is independently an alkyl group comprising at least 6 carbon atoms, and n is an integer equal to or greater than 10.

2. The block copolymer of claim 1, wherein at least one of the following is met:
(i) m is in a range from 10 to 500; and
(ii) n is in a range from 10 to 500.

3. The block copolymer of claim 1, wherein at least one of the following is met:
(i) the PAO block has a number average molecular weight in a range from 3,000 to 50,000 grams·mole⁻¹;
(ii) the PAMA block has a number average molecular weight in a range from 1,000 to 30,000 grams·mole⁻¹; and
(iii) the block copolymer has an overall number average molecular weight in a range from 4,000 to 80,000 grams·mole⁻¹.

4. The block copolymer of claim 1, wherein the PAO block is formed by polymerization of the at least one alpha-olefin monomer in the presence of a coordination polymerization catalyst system under polymerization conditions to effect insertion polymerization.

5. The block copolymer of claim 4, wherein the coordination polymerization catalyst system comprises one of the following: (i) a Ziegler-Natta catalyst; and (ii) a metallocene compound.

6. The block copolymer of claim 1, wherein the PAO block consists essentially of component(s) represented by the structure within the brackets in formula (F-I).

7. The block copolymer of claim 1, wherein the PAMA block is produced by polymerization of at least one alkyl methacrylate monomer in the presence of a radical polymerization catalyst system under polymerization conditions to effect radical addition polymerization.

8. The block copolymer of claim 1, comprising a linking group between the PAO block and the PAMA block, the linking group covalently connected to the PAO block and the PAMA block.

9. The block copolymer of claim 8, wherein the linking group has a structure within the brackets “[ ]” of the following formula (F-III.1), (F-III.2) or (F-III.3): 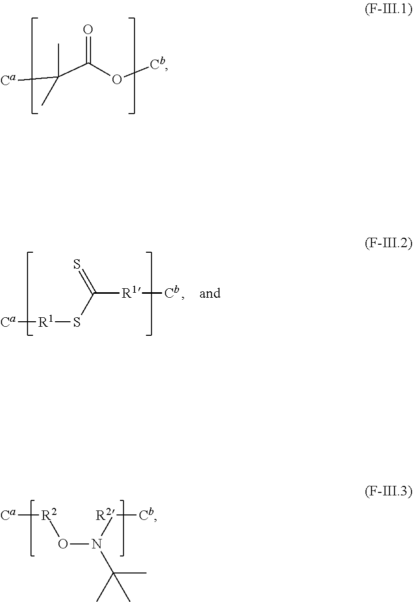
where R¹, R^{1′}, R², and R^{2′} are independently divalent hydrocarbyls, C^{a} is a carbon atom in the PAMA block, and C^{b} is a carbon atom in the PAO block.

10. The block copolymer of claim 1, comprising a single PAO block and a single PAMA block.

11. The block copolymer of claim 1, wherein:
each R in formula (F-I), the same or different at each occurrence in the respective unit, is a linear alkyl group; and/or
each R′ in formula (F-II), the same or different at each occurrence in the respective unit, is independently a linear or branched alkyl group.

12. A viscosity improver for a lubricant oil composition comprising a block copolymer of claim 1.

13. A viscosity improver of claim 12, having the following attribute:
when blended with a PAO base stock having a KV100 of 4.0 cSt to form a mixture having a concentration of the block copolymer at 0.5 wt % based on the total weight of the mixture formed, the mixture exhibits a shear-thinning onset shear rate at 100° C. of no higher than 1×10⁵ s⁻¹.

14. The viscosity improver of claim 13, further having the following attribute:
when blended with a PAO base stock having a KV100 of 4.0 cSt to form a mixture at a concentration of the block copolymer at 0.5 wt % based on the total weight of the mixture formed, the mixture produced exhibits shear thinning at 100° C. at a shear rate of 1×10⁶ s⁻¹.

15. A lubricant oil composition comprising a block copolymer of a claim 1 at a concentration in a range from 0.1 to 5 wt %, based on the total weight of the lubricant oil composition.

16. The lubricant oil composition of claim 15, further comprising a Group I, II, III, or IV base stock having a KV100 in a range from 1.0 to 1000 cSt.

17. A process for making a block copolymer, the process comprising:
(I) polymerizing one or more linear alpha olefin monomer having more than six carbon atoms per molecule in the presence of a coordination insertion polymerization catalyst system to obtain an oligomerization reaction mixture;
(II) obtaining an alpha-olefin polymer mixture olefin (“PAO olefin”) comprising vinyl, vinylidene and/or tri-substituted olefins from the oligomerization reaction mixture;
(III) reacting the PAO olefin with an ATRP agent to obtain a macro radical polymerization initiator comprising a component corresponding to the PAO olefin;
(IV) mixing the macro radical polymerization initiator with an alkyl methacrylate monomer having the following formula: 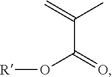
wherein the R′ group is an alkyl group comprising at least 6 carbon atoms; and
(V) initiating ATRP polymerization of the alkyl methacrylate monomer under ATRP polymerization conditions to obtain a polymerization reaction mixture comprising a block copolymer comprising a block corresponding to the PAO olefin (“PAO block”) and a block derived from the alkyl methacrylate monomer.

18. The process of claim 17, wherein:
in step (I), the coordination catalyst system comprises a metallocene compound or a Ziegler-Natta catalyst.

19. The process of claim 16, wherein in step (I), the PAO olefin comprises at least 50 mol % of vinylidenes based on the total moles of the PAO olefin.

20. The process of claim 17, wherein the PAO olefin has a number average molecular weight in the rage from 3,000 to 50,000 grams mole⁻¹.

21. The process of claim 17, wherein in step (V), the ATRP polymerization conditions are chosen such that the average molecular weight of the PAMA block is in a range from 1,000 to 30,000 grams·mole⁻¹.

22. The process of claim 17, wherein overall number average molecular weight of the block copolymer is in a range from 4,000 to 80,000 grams mole⁻¹.

23. The process of claim 17, wherein in step (III), the ATRP agent is: 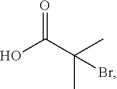
and the reaction in step (III) is carried out in the presence of an acid.

24. The process of claim 17, wherein step (V) is carried out in the presence of a catalyst system comprising CuX, where X is a halide.

25. The process of claim 17, further comprising the following step (VI) after step (V):
(VI) quenching the polymerization reaction mixture by water or an alcohol.
